(19) United States
(12) Patent Application Publication
(10) Pub. No.: US 2005/0142485 A1
(43) Pub. Date: Jun. 30, 2005

(54) Image recording material

(75) Inventors: Ippei Nakamura, Shizuoka-ken (JP); Kazuto Kunita, Shizuoka-ken (JP); Yusuke Hatanaka, Shizuoka-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/020,317

(22) Filed: Dec. 27, 2004

(30) Foreign Application Priority Data
Dec. 26, 2003 (JP) 2003-433713

(51) Int. Cl. G03C 1/76

(52) U.S. Cl. 430/270.1

(57) ABSTRACT

An infrared laser-sensitive positive type image recording material comprises a support; an alkali-developer-soluble first layer formed over the support; and a second layer formed over the first layer, the solubility of the second layer in alkali-developer being improved by exposure of the second layer to an infrared laser. The first layer comprises a polymer having a structural unit represented by formula (I): 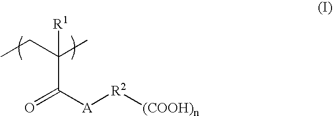
wherein R¹ represents a hydrogen atom or a methyl group; R² represents a hydrocarbon group having (n+1) valences and having an aliphatic ring structure having 3 to 30 carbon atoms; A represents an oxygen atom or —NR³— wherein R³ represents a hydrogen atom or a monovalent hydrocarbon group having 1 to 10 carbon atoms; and n is an integer of from 1 to 5.

### CROSS-REFERENCE TO RELATED APPLICATION

This application claims priority under 35 USC 119 from Japanese patent application, No. 2003-433713, the disclosure of which is incorporated by reference herein.

### BACKGROUND OF THE INVENTION

1. Field of the Invention

The present invention relates to an image recording material, provided on a support and comprising a photosensitive/heat sensitive layer with improved solubility to an alkaline developer by exposure. More particularly it relates to a so-called direct plate-making positive image recording material usable for direct plate-making by scanning a laser beam with a high energy density, such as an infrared laser beam, based on digital signals from a computer or the like.

2. Description of the Related Art

Lasers have advanced remarkably recently, and especially compact and high powered solid lasers and semiconductor laser, having light emissions in the near infrared to infrared regions, have become readily available. Recording by changing the solubility of photosensitive resins by exposure using such high power lasers (generally, the exposure energy density is greater than 5 kW to 10 kW/cm²) is called heat mode recording or thermal recording. This way of recording has recently been drawing attention in the field of planographic printing for recording in direct plate-making methods for directly producing master plates from digital data of a computer or the like.

Specifically, commercialized and made available are: thermal positive type planographic printing plate precursors, comprising photosensitive layers provided on a support and whose solubility is increased by high power laser exposure (called positive type photosensitive layers); or thermal negative type planographic printing plates comprising photosensitive layers provided on a support whose solubility is decreased by high power laser exposure (called negative type photosensitive layers).

Positive type image recording materials for infrared lasers for direct plate making are image recording materials obtained by adding to an alkali-soluble resin a substance which absorbs light and generates heat, and a positive type photosensitive compound, such as a quinonediazido compound. The positive type photosensitive compound works as a dissolution inhibitor by effectively decreasing the solubility of the aqueous alkaline solution-soluble resin in the image areas. And in the non-image areas, the photosensitive compound is decomposed by heat and therefore does not show dissolution inhibition, and the aqueous alkaline solution-soluble resin becomes removable by development to form images. A variety of alkali-soluble resins and dissolution inhibitors are proposed (reference to Japanese Patent Application Laid-Open Nos. 7-285275, 10-268512, and Japanese Patent Application National Publication No. 11-506550).

However, known photosensitive compositions used as recording layers of known thermal positive type planographic printing plate precursors have insufficient difference of the solubility to developers between exposed portions and non-exposed portions (solubility discrimination) and excess development or defective development attributed to variation of conditions of use is easily caused and accordingly, problems often results where the contrast of images developed after exposure becomes insufficient.

As a method for improving the image discrimination of a positive type planographic printing plate material, techniques of adding phenolic hydroxyl-containing compounds have been proposed (reference to Japanese Patent Application Laid-Open (JP-A) No. 2000-241966). However, whilst the phenolic hydroxyl-containing compounds improve the removability (solubility) of the non-image portions to alkaline developers, on the other hand, the compounds also, at the same time, increase the solubility of the image portions. This means that the sharpness of images deteriorates and this tendency is particularly noticeable in the case of thin lines and dotted image regions with low density coverage. In such situations, an improvement in image recording materials in terms of contrast has been desired.

### SUMMARY OF THE INVENTION

The present invention has been made in view of the above circumstances and provides a positive image recording material which makes possible producing a printing plate at a high sensitivity directly from digital data of a computer or the like, which material enables recording by infrared laser to be carried out and gives excellent latitude in development and high contrast even in portions which are doted or have thin lines.

After intensive research, the present inventors have discovered that the above-mentioned objective can be achieved by adding a polymer having a specific structure to a lower layer of a recording layer having a bi-layered structure, and have thus devised the present invention.

Specifically, the invention is an infrared-laser-sensitive positive type image recording material that comprises a support, an alkali-developer-soluble first layer formed over the support, and a second layer formed over the first layer, the solubility of the second layer in alkali-developer being improved by exposure thereof to an infrared laser, wherein the first layer comprises a polymer having a structural unit represented by formula (I): 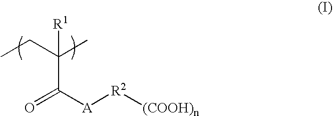
wherein R¹ represents a hydrogen atom or a methyl group; R² represents a hydrocarbon group having (n+1) valences and having an aliphatic ring structure having 3 to 30 carbon atoms; A represents an oxygen atom or —NR³— wherein R³ represents a hydrogen atom or a monovalent hydrocarbon group having 1 to 10 carbon atoms; and n is an integer in the range of 1 to 5.

The mechanism for the effect of the invention is unclear, but can be presumed as follows.

When the above-mentioned polymer, which has a structural unit represented by formula (I), is added to the alkali-soluble first layer in the planographic printing plate precursor of the invention, this polymer, due to the structure thereof, interacts with an alkali-soluble polymer or forms a micro-phase separation structure, through hydrogen bonding or the like.

For this reason, a lower layer is formed with superior film strength, and with superior antisolubility in alkali developer particularly as regards antisolubility from the periphery of image portions in the image recording layer (toward the centers thereof in a lateral direction.

As a result, in the image portions, that is, the areas where the upper image recording layer is present as an alkali-development-resistant layer, high film strength and alkali development-resistance function more effectively than in any conventional alkali-soluble lower layer. Even in images having a small area, such as fine lines or dots, it is possible to effectively suppress image defects resulting from a fall in the strength of the first layer, a decrease in the ratio of the image portions to power, and other drawbacks. On the other hand, in the non-image portions, where the second layer is removed, an originally higher alkali-solubility, based on the carboxyl groups present in the polymer structure, is exhibited, since the above-mentioned interaction is easily cancelled by heat. Consequently, the non-image portions are rapidly dissolved and dispersed.

As described above, this effect is remarkable, in particular, in fine lines, fine dots, and similar areas. As a result, it is possible to suppress reductions in resolution and development discrimination accompanying increased sensitivity, which has remained a problem in the prior art. In other words, it appears that the recording material of the invention can exhibit high resolution and higher development discrimination while retaining high sensitivity.

Namely, according to the image recording material of the invention, images are recorded by use of a solid laser or semiconductor laser emitting an infrared laser, whereby a printing plate can be formed at a high sensitivity by direct use of digital data from a computer or the like and images superior in development latitude and contrast and high in resolution can be formed.

### DETAILED DESCRIPTION OF THE INVENTION

The present invention is described in detail hereinafter.

The positive type image recording material of the invention comprises a support, an alkali-developer-soluble first layer formed over the support (hereinafter, the first layer being referred to as the “lower layer” as appropriate) and a second layer formed over the first layer (hereinafter, the second layer being referred to as the “upper layer” as appropriate), the solubility thereof in alkali-developer being improved by exposure of the second layer to an infrared laser, wherein the first layer comprises a polymer having a structural unit represented by the following general formula (I): 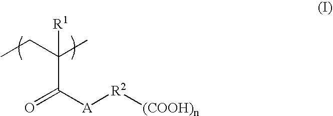
wherein R¹ represents a hydrogen atom or a methyl group; R² represents a hydrocarbon group having (n+1) valences and having an aliphatic ring structure having 3 to 30 carbon atoms; A represents an oxygen atom or —NR³— wherein R³ represents a hydrogen atom or a monovalent hydrocarbon group having 1 to 10 carbon atoms; and n is an integer of from 1 to 5 (hereinafter, the polymer being referred to as the “specific polymer” as appropriate).

Since the image-recording medium of the invention has the above-mentioned structure, the upper layer has, in its image portions, a good film property and alkali development resistance when the upper layer is in an unexposed state. Therefore, the surface of the image portions has a high alkali development resistance. The lower layer is superior in antisolubility in alkali-developer and, in particular, antisolubility from the periphery of the image portions toward the centers thereof in a lateral direction.

Inside the exposed areas, that is, the non-image portions, development resistance based on a development inhibitor is rapidly cancelled by the exposure of the areas to light in not only the upper layer but also the lower layer. When the upper layer is developed and removed, the lower layer, which is soluble in alkali developer, is laid bare. In this way, the lower layer exhibits a high solubility in aqueous alkaline solution, which results from components contained in the lower layer. Consequently, the lower layer is rapidly removed so that the support, which is hydrophilic, is in turn laid bare. As a result, superior images are formed without any concomitant staining of the non-image portions.

[First Layer]

The first layer (lower layer) in the invention is a layer that is soluble in alkali developer and is formed between the support and the second layer (upper layer), which will be detailed below. It is essential that the first layer comprises a polymer having a structural unit represented by the general formula (I). The following describes components contained in the first layer.

[Polymer Having a Structural Unit Represented by the General Formula (I)]

The polymer having a structural unit represented by the general formula (I) (specific polymer), which is a characteristic component in the invention, is described in detail.

First, in the general formula (I), R¹ represents a hydrogen atom or a methyl group, and is preferably a methyl group.

In the general formula (I), R² represents a hydrocarbon group having (n+1) valences and having an aliphatic ring structure having 3 to 30 carbon atoms. This hydrocarbon group may have one or more substituents. The number of total carbon atoms in the hydrocarbon group including the optional substituent(s) needs to be from 3 to 30.

This hydrocarbon group, which has an aliphatic ring structure and has (n+1) valences, may be a hydrocarbon group obtained by removing (n+1) hydrogen atoms from any of the plural carbon atoms constituting a compound which has an aliphatic ring structure (the compound may be substituted with any substituent), thereby making the carbon atoms have (n+1) valences. Example of the compound include cyclopropane, cyclopentane, cyclohexane, cycloheptane, cyclooctane, cyclodecane, dicyclohexyl, tercyclohexyl, norbornane, decahydronaphthalene, perhydrofluorene, tricyclo[5.2.1.0^{2.6}]decane, adamantane, quadricyclane, congressane, cubane, spiro[4.4]octane, cyclopentene, cyclohexene, cycloheptene, cyclooctene, cyclodecene, cyclohexadiene, cycloheptadiene, cyclooctadiene, cycloheptatriene, cyclodecatriene, cyclooctatetraene, norbornylene, octahydronaphthalene, bicycle[2.2.1]heptadiene, bicyclo[4.3.0]nonadiene, dicyclopentadiene, hexahydroanthracene, and spiro[4.5]decadiene.

Of these hydrocarbon groups, preferable are structures having a monocyclic ring having about 5 or 6 carbon atoms, such as cyclohexane or cyclohexene, structures having a bicyclic ring such as norbornane, and structures having a tricyclic ring such as tricyclo[5.2.1.0^{2.6}]decane, and particularly preferable are structures having a monocyclic ring having about 6 carbon atoms in order to improve the antisolublity of the first layer (lower layer) in the lateral direction.

Any one carbon atom or any plural carbon atoms in the compound constituting the aliphatic ring structure in R² may be substituted with one or more heteroatoms selected from nitrogen, oxygen or sulfur atoms. From the viewpoint of the printing resistance of the recording material, R² is preferably a hydrocarbon group having (n+1) valences, having 5 to 30 carbon atoms (more preferably 5 to 15 carbon atoms), and having an aliphatic ring structure which has two or more rings (such as a condensed poly-ring aliphatic hydrocarbon, a bridged-ring aliphatic hydrocarbon, a spiro-aliphatic hydrocarbon, or an aliphatic hydrocarbon ring cluster) and which may have a substituent. In this case, the number of the carbon atoms is the total number of the carbon atoms in the cyclic group and the optional substituent(s) thereof.

Examples of the substituent, which can be introduced into R² are monovalent non-metal atomic groups other than hydrogen. Preferable examples thereof include halogen atoms (such as —F, —Br, —Cl and —I), a hydroxyl group, alkoxy groups, aryloxy groups, a mercapto group, alkylthio groups, arylthio groups, alkyldithio groups, aryldithio groups, an amino group, N-alkylamino groups, N,N-dialkylamino groups, N-arylamino groups, N,N-diarylamino groups, N-alkyl-N-arylamino groups, acyloxy groups, carbamonyloxy groups, N-alkylcarbamoyloxy groups, N-arylcarbamoyloxy groups, N,N-dialkylcarbamoyloxy groups, N,N-diarylcarbamoyloxy groups, N-alkyl-N-arylcarbamoyloxy groups, alkylsulfoxy groups, arylsulfoxy groups, acylthio groups, acylamino groups, N-alkylacylamino groups, N-arylacylamino groups, ureido groups, N′-alkylureido groups, N′,N′-dialkylureido groups, N′-arylureido groups, N′,N′-diarylureido groups, N′-alkyl-N′-arylureido groups, N-alkylureido groups, N-arylureido groups, N′-alkyl-N-alkylureido groups, N′-alkyl-N-arylureido groups, N′,N′-dialkyl-N-alkylureido groups, N′,N′-dialkyl-N-arylureido groups, N′-aryl-N-alkylureido groups, N′-aryl-N-arylureido groups, N′,N′-diaryl-N-alkylureido groups, N′,N′-diaryl-N-arylureido groups, N′-alkyl-N′-aryl-N-alkylureido groups, N′-alkyl-N′-aryl-N-arylureido groups, alkoxycarbonylamino groups, aryloxycarbonylamino groups, N-alkyl-N-alkoxycarbonylamino groups, N-alkyl-N-aryloxycarbonylamino groups, N-aryl-N-alkoxycarbonylamino groups, N-aryl-N-aryloxycarbonylamino groups, a formyl group, acyl groups, a carboxyl groups and conjugate base groups thereof (hereinafter referred to as carboxylates), alkoxycarbonyl groups, aryloxycarbonyl groups, a carbamoyl group, N-alkylcarbamoyl groups, N,N-dialkylcarbamoyl groups, N-arylcarbamoyl groups, N,N-diarylcarbamoyl groups, N-alkyl-N-arylcarbamoyl groups, alkylsulfinyl groups, arylsulfinyl groups, alkylsulfonyl groups, arylsulfonyl groups, a sulfo group (—SO₃H) and conjugate salt groups thereof (hereinafter referred to as sulfonate groups), alkoxysulfonyl groups, aryloxysulfonyl groups, sulfinamoyl groups, N-alkylsulfinamoyl groups, N,N-dialkylsulfinamoyl groups, N-arylsulfinamoyl groups, N,N-diarylsulfinamoyl groups, N-alkyl-N-arylsulfinamoyl groups, a sulfamoyl group, N-alkylsulfamoyl groups, N,N-dialkylsulfamoyl groups, N-arylsulfamoyl groups, N,N-diarylsulfamoyl groups, N-alkyl-N-arylsulfamoyl groups, N-acylsulfamoyl groups and conjugate salt groups thereof, N-alkylsulfonylsulfamoyl groups —SO₂NHSO₂(alkyl)) and conjugate salt groups thereof, N-arylsulfonylsulfamoyl (—SO₂NHSO₂(allyl)) and conjugate salt groups thereof, N-alkylsulfonylcarbamoyl groups (—CONHSO₂(alkyl)) and conjugate salt groups thereof, N-arylsulfonylcarbamoyl groups (—CONHSO₂(allyl)) and conjugate salt groups thereof, alkoxysilyl groups (—Si(Oalkyl)₃), aryloxysilyl groups (—Si(Oallyl)₃), hydroxysilyl groups (—Si(OH)₃) and conjugate salt groups thereof, a phosphono group (—PO₃H₂) and conjugate salt groups thereof (hereinafter referred to as phosphonate groups), dialkylphosphono groups (—PO₃(alkyl)₂), diarylphosphono groups (—PO₃(aryl)₂), alkylarylphosphono groups (—PO₃(alkyl)(aryl)), monoalkylphosphono groups (—PO₃H(alkyl)) and conjugate salt groups thereof (hereinafter referred to as alkylphosphonates groups), monoarylphosphono groups and conjugate salt groups thereof (hereinafter referred to as arylphosphonates groups), a phosphonoxy group and conjugate salt groups thereof (hereinafter referred to as phosphonateoxy groups), dialkylphosphonoxy groups (—OPO₃(alkyl)₂), diarylphosphonoxy groups (—OPO₃(aryl)₂), alkylarylphosphonoxy groups (—OPO₃(alkyl) (aryl)), monoalkylphosphonoxy groups (—OPO₃H (alkyl)) and conjugate salt groups thereof (hereinafter referred to as alkylphosphonateoxy groups), monoarylphosphonoxy groups (—OPO₃H(aryl)) and conjugate salt groups thereof (hereinafter referred to as arylphosphonateoxy groups), a cyano group, a nitro group, dialkylboryl groups (—B(alkyl)₂), diarylboryl groups (—B(aryl)₂), alkylarylboryl groups (—B(allyl)(aryl)), dihydroxyboryl groups (—B(OH)₂) and conjugate salt groups thereof, alkylhydroxyboryl groups (—B(alkyl)(OH) and conjugate salt groups thereof, arylhydroxyboryl groups (—B(aryl)(OH) and conjugate salt groups thereof, aryl groups, alkenyl groups, and alkynyl groups.

Substituents having a hydrogen atom which can undergo hydrogen bonding, in particular, acidic substituents having a smaller acid dissociation constant (pKa) than carboxylic acid tend to lower the effect of restraining the penetration of developer. It is therefore not preferable to use them. Hydrophobic substituents such as halogen atoms and hydrocarbon groups (such as alkyl, aryl, alkenyl, and alkynyl groups), alkoxy groups, and aryloxy groups are more preferable since they are useful for the effect of restraining the penetration of the developer, as described above. In the case that the ring structure is, in particular, a monocyclic aliphatic hydrocarbon having a 6 or fewer membered ring, such as cylopentane or cyclohexane, it is preferable that the hydrocarbon has such a hydrophobic substituent. If possible, the substituents, which can be introduced into R² may be combined with each other, or one out of the substituents may be combined with the hydrocarbon group having this substituent, so as to form a ring. The substituent(s) may be further substituted.

In the general formula (I), A represents an oxygen atom or —NR³— wherein R³ represents a hydrogen atom or a monovalent hydrocarbon group having 1 to 10 carbon atoms.

Examples of the monovalent hydrocarbon group represented by R³, which has 1 to 10 carbon atoms, include alkyl, aryl, alkenyl, and alkynyl groups. The alkyl group may be a straight-chained, branched or cyclic alkyl group having 1 to 10 carbon atoms, and specific examples thereof include methyl, ethyl, propyl, butyl, pentyl, hexyl, heptyl, octyl, nonyl, decyl, isopropyl, isobutyl, sec-butyl, tert-butyl, isopentyl, neopentyl, 1-methylbutyl, isohexyl, 2-ethylhexyl, 2-methylhexyl, cyclopentyl, cyclohexyl, 1-adamantyl, and 2-norbornyl groups. The aryl group may be an aryl group having 1 to 10 carbon atoms, specific examples thereof including phenyl, naphthyl and indenyl groups; or may be a heteroaryl group having 1 to 10 carbon atoms and containing one or more heteroatoms selected from the groups consisting of nitrogen, oxygen and sulfur atoms, specific examples thereof including furyl, thienyl, pyrrolyl, pyridyl, and quinolyl groups. The alkenyl group may be a straight-chained, branched or cyclic alkenyl group having 1 to 10 carbon atoms, and specific examples thereof include vinyl, 1-propenyl, 1-butenyl, 1-methyl-1-propenyl, 1-cyclopentenyl and 1-cyclohexenyl groups. The alkynyl group may be an alkynyl group having 1 to 10 carbon atoms, and specific examples thereof include ethynyl, 1-propynyl, 1-butynyl, and 1-octynyl groups.

R³ may further have a substituent. Examples of the substituent, which can be introduced, are the same substituents as exemplified for R². However, the number of the carbon atoms in R³, which include the carbon atoms in the optional substituent(s) therein, needs to be from 1 to 10. A is preferably an oxygen atom or NH since the structural unit or the specific polymer can easily be synthesized.

n is an integer of 1 to 5, and is preferably 1 from the viewpoint of the printing resistance of the recording material.

The molecular weight of the specific polymer in the invention is preferably from 2,000 to 1,000,000, more preferably from 5,000 to 500,000, and even more preferably from 10,000 to 200,000.

The specific polymer may be a polymer made only of the structural units represented by the general formula (I), or a copolymer made from the formula (I) structural units and different structural units. In the latter case, the amount of the structural units represented by the general formula (I) is preferably 5% or more by mole, and more preferably 10% or more by mole.

Examples of the kind of the copolymerizable different units, which will be detailed below, include (meth)acrylic acid and derivatives thereof, styrene and derivatives thereof, and acrylonitrile. Of these examples, (meth)acrylic acid derivatives are preferable. Particularly preferable are (meth)acrylic alkyl esters each having an alkyl group having 1 to 4 carbon atoms, such as methyl(meth)acrylate, ethyl(meth)acrylate, isopropyl (meth)acrylate, n-butyl(meth)acrylate, and isobutyl(meth)acrylate.

Preferable and specific examples of the structural unit represented by the general formula (I) are illustrated below. In the invention, however, the structural unit is not limited to these examples.

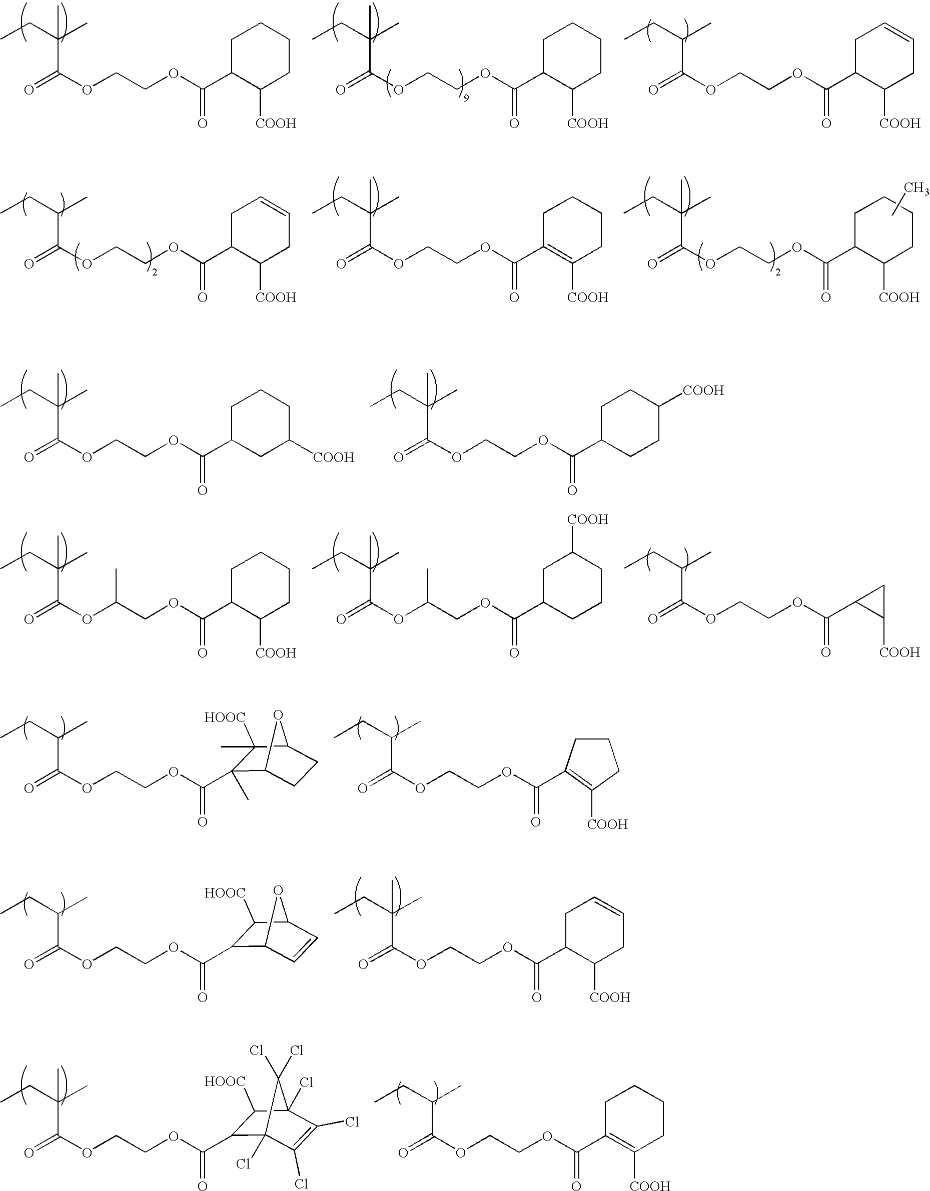

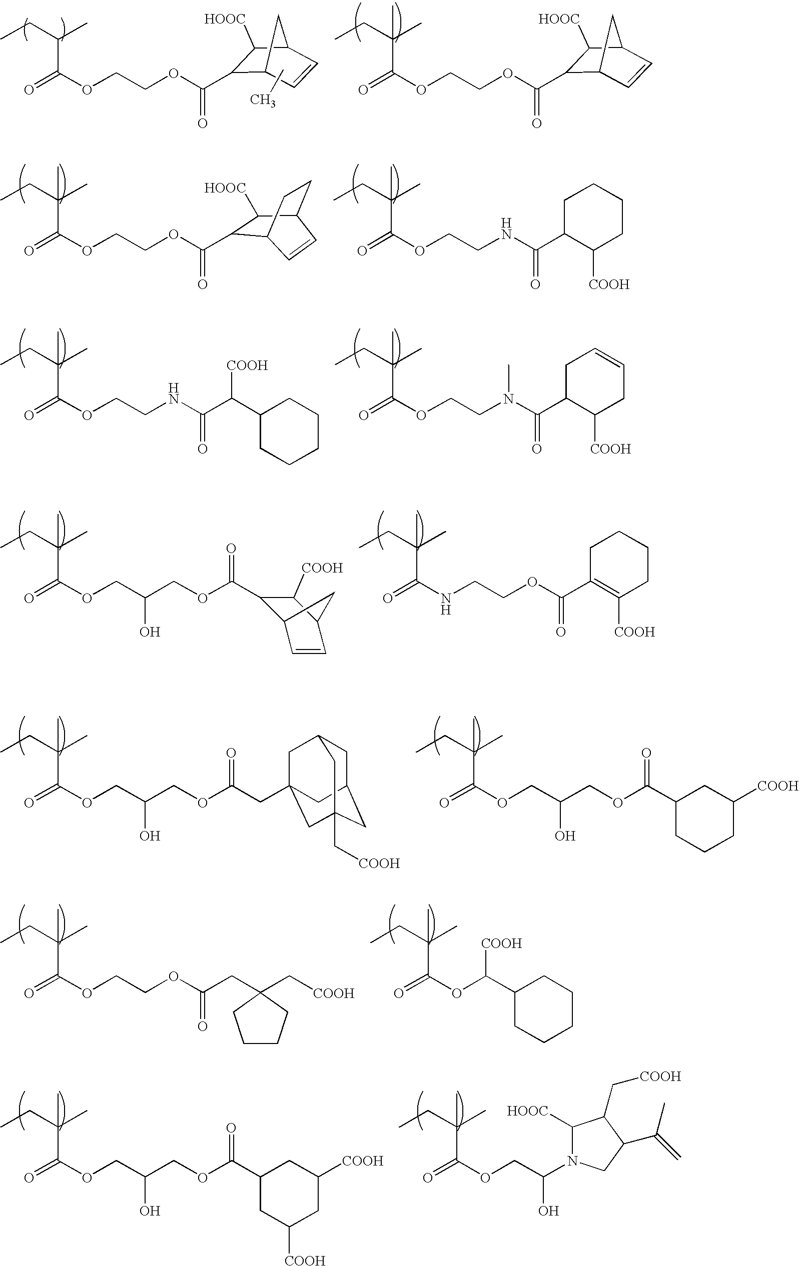

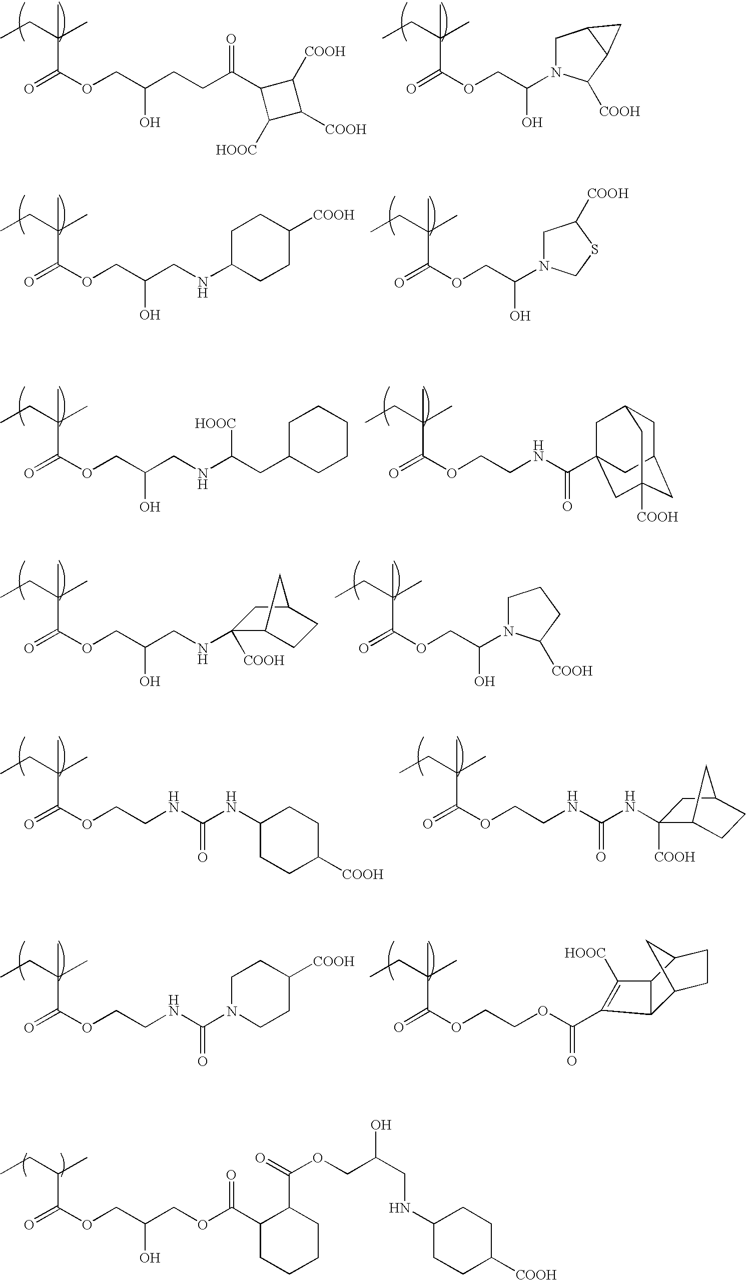

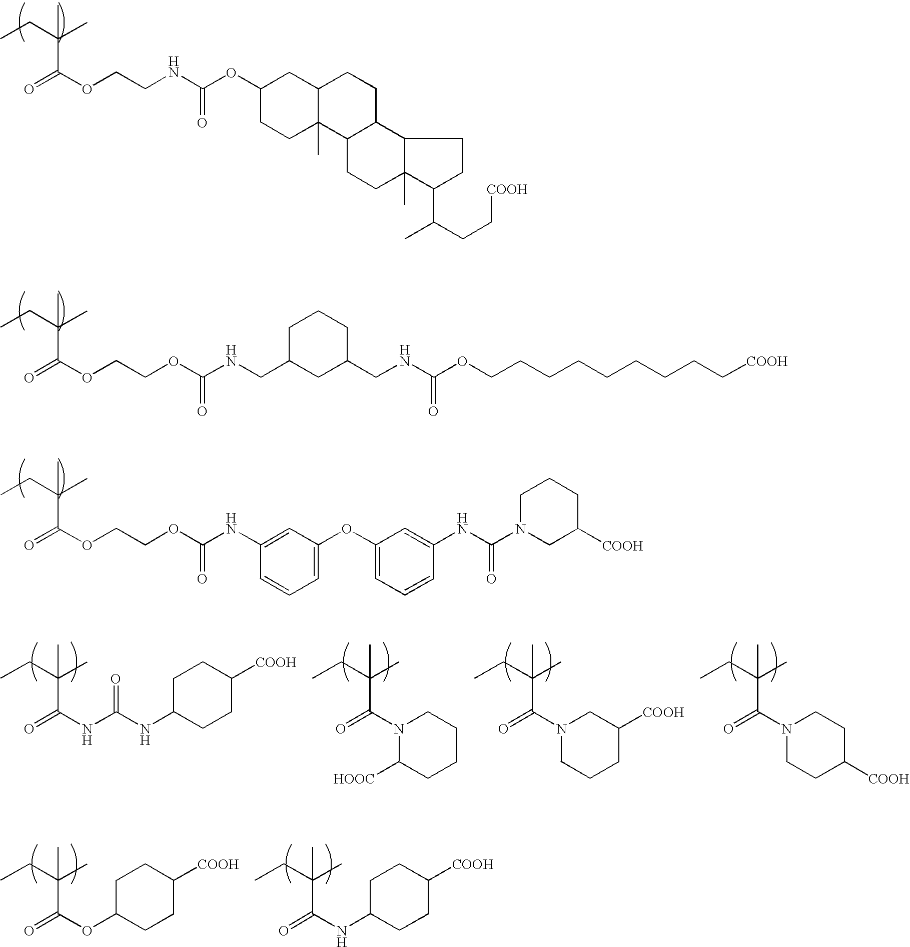

The specific polymers according to the invention may be used alone or in combination of two or more thereof.

The specific polymer(s) according to the invention is(are) added to the lower layer preferably in an amount of 1 to 30% by mass of all solid content in the lower layer, and more preferably in an amount of 3 to 18% by mass thereof. When the amount is in this range, superior development latitude and image contrast, as well as coating film properties, which are advantageous effects of the invention, are satisfactorily exhibited and, further, film properties of the coating layer are also improved.

The lower layer of the invention is required to be soluble in the alkaline developer and in terms of the solubility, it is preferable to contain an alkali-soluble resin as a main component. As the alkali-soluble resin to be used for the lower layer, those described in detail below with regard to the upper (second) layer are preferable. Among them, in terms of the sensitivity and the image formability, resins which exhibits less interactive reaction than the alkali-soluble resin to be used for the upper layer and thus is more excellent in the solubility to the alkaline developer are preferably selected. Preferable examples thereof include polyamide resin, epoxy resin, acetal resin, acrylic resin, methacrylic resin, styrene resin, and urethane resin.

The alkali-soluble resin to be used for the lower layer is preferably selected from resins having low solvent solubility and not dissolved in the coating solvent at the time of the application of the top (upper) layer. Undesired compatibility in the interlayer between two layers can be suppressed by selecting such a resin. From such a viewpoint, among the above-mentioned resins, acetal resin, acrylic resin, and urethane resin are particularly preferable.

Examples of the alkali-soluble resin, which can be preferably used, are alkali-soluble resins having a high polarity unit such as vinyl polymers having, on side chains thereof, a barbituric acid skeleton. Specific examples thereof include a copolymer made from N-(p-aminosulfonylphenyl) (meth)acrylamide, (meth)acrylic alkyl esters, and acrylonitrile; a copolymer made from 4-maleimidebenzenesulfonamide and styrene; a copolymer made from (meth)acrylic acid, N-phenylmaleimide and (meth)acrylamide. However, the alkali-soluble resin is not limited to these examples.

The amount of the alkali-soluble resin contained in the lower layer according to the invention is from about 40 to 95%, and preferably from about 50 to 90% by mass of all solid content in the lower layer.

The ratio by mass of the specific polymer to the alkali-soluble resin in the lower layer is preferably from 1/99 to 25/75, and more preferably from 3/97 to 15/85.

[Other Components]

In the lower layer, other components, such as a photothermal conversion material and various additives, may be used together with the alkali-soluble resin. As the other components, the same components as described with respect to the second layer (upper layer), which will be detailed below, can be used in the same manner.

[Second Layer]

The following describes the second layer (upper layer), the solubility thereof in alkali developer being improved by exposure thereof to an infrared laser. A preferable embodiment of this upper layer comprises an alkali-soluble resin and a photothermal conversion material. Hereinafter, components, which constitute the upper layer are described.

[Alkali-Soluble Resin]

Examples of the alkali-soluble resin (A) to be used in the image recording material of the invention may include homopolymers containing acidic groups in the main chains and/or the side chains of the polymers, their copolymers, or their mixtures.

Among them, polymers having the following acidic groups (1) to (6) in the main chains and/or side chains are preferable in terms of the development resistance and the solubility to an aqueous alkaline solution:
(1) phenol (—Ar—OH),
(2) sulfone amide (—SO₂NH—R),
(3) substituted sulfoneamido based acid group (hereinafter, referred to as active imido group) [—SO₂NHCOR, —SO₂NHSO₂R, —CONHSO₂R]
(4) carboxylic acid group (—CO₂H),
(5) sulfonic acid group (—SO₃H), and
(6) phosphoric acid group (—OPO₃H₂)

Ar in the above-mentioned groups (1) to (6) represents a divalent aryl bonding group optionally comprising a substituent group and R represents a hydrocarbon group optionally comprising a substituent group.

Among the alkali-soluble resin comprising the acidic group selected from the above-mentioned (1) to (6), an alkali-soluble resin comprising (1) phenol, (2) sulfone amide, or (3) active imido group is preferable and an alkali-soluble resin comprising (1) phenol or (2) sulfone amide is more preferable in terms of assurance of the sufficient solubility in an alkaline developer, development latitude, and film strength.

As the alkali-soluble resin comprising the acidic group selected from the above-mentioned (1) to (6), the following can be exemplified.

(1) Examples of the alkali-soluble resin comprising phenol group may include novolak resin such as condensation polymers of phenol and formaldehyde; condensation polymers of m-cresol and formaldehyde, condensation polymers of p-cresol and formaldehyde, condensation polymers of m-/p-mixed cresol and formaldehyde, and condensation polymers of phenol, cresol (m-, p-, or m-/p-mixture) and formaldehyde; and condensation copolymers of pyrogallol and acetone. Further, copolymers obtained by copolymerizing compound comprising phenyl groups in the side chains can be exemplified. Or, copolymers obtained by copolymerizing compounds comprising phenyl groups in the side chains can also be used.

As the compounds comprising phenol group, acrylamide, methacrylamide, acrylic acid ester, methacrylic acid ester, or hydroxystyrene can be exemplified.

(2) Examples of the alkali-soluble resin comprising sulfoneamido group may include polymers obtained by using the minimum component units derived from compounds comprising sulfoneamido group as main constituent components. Examples of such compounds include those having at least one sulfoneamido group comprising at least one hydrogen atom bonded to the nitrogen atom and at least one polymerizable unsaturated group, in the molecules. Among them, low molecular weight compounds comprising acryloyl, allyl, or vinyloxy group as well as substituted or mono-substituted aminosulfonyl group or a substituted sulfonylimino group in molecules are preferable and the following compounds defined by the following (i) to (v) can be exemplified.

Examples thereof include compounds represented by any one of the following general formulae (i) to (v):

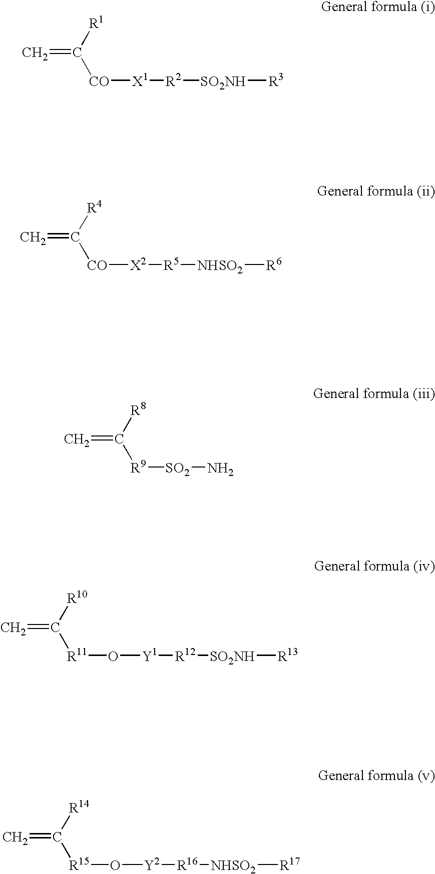

In the general formulae (i) to (v), X¹ and X² each independently represent —O—, or —NR⁷—; R¹ and R⁴ each independently represent a hydrogen atom, or —CH₃; R², R⁵, R⁹, R¹² and R¹⁶ each independently represent an alkylene, cycloalkylene, arylene or aralkylene group which may have a substituent and has 1 to 12 carbon atoms; R³, R⁷ and R¹³ each independently represent a hydrogen atom, or an alkyl, cycloalkyl, aryl or aralkyl group which may have a substituent and has 1 to 12 carbon atoms; R¹ and R¹⁷ each independently represent an alkyl, cycloalkyl, aryl or aralkyl group which may have a substituent and has 1 to 12 carbon atoms; R⁸, R¹⁰ and R¹⁴ each independently represent a hydrogen atom or —CH₃; R¹¹ and R¹⁵ each independently represent a single bond, or an alkylene, cycloalkylene, arylene or aralkylene group which may have a substituent and has 1 to 12 carbon atoms; and Y¹ and Y² each independently represent a single bond or —CO—.

Of the compounds represented by the represented by the general formulae (i) to (v), in particular, the following can preferably be used in the invention: m-aminosulfonylphenyl methacrylate, N-(p-aminosulfonylphenyl)methacrylamide and N-(p-amino sulfonylphenyl)acrylamide.

Examples of the monomer having an active imide group in the item (3) include compounds each having in the molecule thereof one or more active imide groups represented by the above-mentioned structural formula and one or more unsaturated groups which can be polymerized with the active imide group(s). Of these compounds, preferable are compounds each having in the molecule thereof one or more active imide groups represented by the following structural formula and one or more unsaturated groups which can be polymerized with the active imide group(s):

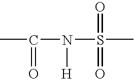

Specifically, N-(p-toluenesulfonyl)methacrylamide, N-(p-toluenesulfonyl)acrylamide and others can be preferably used.

Examples of the monomer having a carboxylic acid group in the item (4) include compounds each having in the molecule thereof one or more carboxylic acid groups and one or more unsaturated groups which can be polymerized with the carboxylic acid group(s).

Examples of the monomer having a sulfonic acid group in the item (5) include compounds each having in the molecule thereof one or more sulfonic acid groups and one or more unsaturated groups which can be polymerized with the sulfonic acid group(s).

Examples of the monomer having a phosphoric acid group in the item (6) include compounds each having in the molecule thereof one or more phosphoric acid group and one or more unsaturated groups which can be polymerized with the phophoric acid group(s).

The minimum constituent unit comprising acidic group selected from (1) to (6) composing an alkali-soluble resin to be used for the image recording material of the invention is not necessarily limited to one particular unit, but those obtained by copolymerizing two or more minimum constituent units comprising the same acidic group or two or more minimum constituent units comprising different acidic groups can also be used.

The above-mentioned copolymer contains the compound having the acidic group selected from (1) to (6) to be copolymerized in an amount preferably 10% by mole or more, more preferably 20% by mole or more. If it is less than 10% by mole, the development latitude tends to be improved insufficiently.

In the invention, in the case the compounds are copolymerized to use the obtained copolymer as the alkali-soluble resin, the compounds to be copolymerized may include other compounds without acidic group (1) to (6). Examples of the compounds without acidic group (1) to (6) inclue the following compounds (m1) to (m12), however they should not be limited to these examples. They are also useful for the copolymer components of the component (C).

(m1) Acrylic acid esters and methacrylic acid esters having aliphatic hydroxyl groups such as 2-hydroxyethyl acrylate or 2-hydroxyethyl methacrylate.

(m2) Alkyl acrylate such as methyl acrylate, ethyl acrylate, propyl acrylate, butyl acrylate, amyl acrylate, hexyl acrylate, octyl acrylate, benzyl acrylate, 2-chloroethyl acrylate, and glycidyl acrylate.

(m3) Alkyl methacrylate such as methyl methacrylate, ethyl methacrylate, propyl methacrylate, butyl methacrylate, amyl methacrylate, hexyl methacrylate, cyclohexyl methacrylate, benzyl methacrylate, 2-chloroethyl methacrylate, and glycidyl methacrylate.

(m4) Acrylamide or methacrylamide such as acrylamide, methacrylamide, N-methylol acrylamide, N-ethylacrylamide, N-hexylmethacrylamide, N-cyclohexylacrylamide, N-hydroxyethylacrylamide, N-phenylacrylamide, N-nitrophenylacrylamide, and N-ethyl-N-phenylacxrylamide.

(m5) Vinyl ethers such as ethyl vinyl ether, 2-chloroethyl vinyl ether, hydroxyethyl vinyl ether, propyl vinyl ether, butyl vinyl ether, octyl vinyl ether, and phenyl vinyl ether.

(m6) Vinyl esters such as vinyl acetate, vinyl chloroacetate, vinyl butylate, and vinyl benzoate.

(m7) Styrenes such as styrene, α-methylstyrene, methylstyrene, and chloromethylstyrene.

(m8) Vinyl ketones such as methyl vinyl ketone, ethyl vinyl ketone, propyl vinyl ketone, and phenyl vinyl ketone.

(m9) Olefins such as ethylene, propylene, isobutylene, butadiene, and isoprene.

(m10) N-vinylpyrrolidone, acrylonitrile, and methacrylonitrile.

(m11) Unsaturated imides such as maleimide, N-acryloylacrylamide, N-acetylmethacrylamide, N-propionylmethacrylamide, and N-(p-chlorobenzoyl)methacrylamide.

(m12) Unsaturated carboxylic acid such as acrylic acid, methacrylic acid, maleic anhydride, and itaconic acid.

As the alkali-soluble resin, in terms of the excellent image formability by exposure by infrared laser, it is preferable to comprise phenolic hydroxyl groups and preferable examples of the resin to be usable are novolak resins and pyrogallol acetone resins such as phenol formaldehyde resin, m-cresol formaldehyde resin, p-cresol formaldehyde resin, m-/p-mixed cresol formaldehyde resin, and phenol/cresol (either m-, p- or m-/p-mixed) mixed formaldehyde resin.

Also, as the alkali-soluble resin having phenolic hydroxyl groups, condensed copolymers of phenol and formaldehyde comprising alkyl having 3 to 8 carbon atoms such as tert-butylphenol formaldehyde resin and octylphenol formaldehyde resin as a substituent group can be exemplified as described in U.S. Pat. No. 4,123,279.

The alkali-soluble resin has a weight average molecular weight preferably 500 or higher and more preferably 1,000 to 700,000 in terms of the image formability and has a number average molecular weight preferably 500 or higher and more preferably 700 to 650,000. The dispersion (the weight average molecular weight/the number average molecular weight) is preferably 1.1 to 10.

These alkali-soluble resins are used alone and two or more of them may be used in combination. In the case of combination, as described in U.S. Pat. No. 4,123,279, condensed polymers of phenol comprising alkyl having 3 to 8 carbon atoms as a substituent group and formaldehyde such as condensed polymer of tert-butylphenol and formaldehyde, condensed polymer of octyl phenol and formaldehyde, and as described in Japanese Patent Application Laid-Open No. 2000-241972 previously applied by inventors, alkali-soluble resins having phenol structure having electron attractive group in an aromatic ring may be used in combination.

The total content of the alkali-soluble resins of the invention, in the upper layer, is preferably 30 to 98% by weight and more preferably 40 to 95% by weight in total solid components of the upper layer. It is preferable because the durability, the sensitivity, and the image formability are all excellent in the above-mentioned range.

[Photothermal Conversion Substance]

The photothermal conversion substance used in the invention may be any infrared absorbent that absorbs light energy radiating rays to generate heat. The absorption wavelength of the infrared absorbent is not particularly limited. From the viewpoints of suitability to high-power lasers and being readily available, preferable examples thereof include infrared absorbing dyes and pigments having an absorption maximum in a wavelength range of 760 to 1200 nm.

The dyes may be commercially available ones and known ones described in publications such as “Dye Handbook” (edited by the Society of Synthesis Organic Chemistry, Japan, and published in 1970). Specific examples thereof include azo dyes, metal complex azo dyes, pyrazolone azo dyes, naphthoquinone dyes, anthraquinone dyes, phthalocyanine dyes, carbonium dyes, quinoneimine dyes, methine dyes, cyanine dyes, squarylium dyes, pyrylium dyes, metal thiolate complexes, oxonol dyes, diimonium dyes, aminium dyes, and croconium dyes.

Preferable examples of the dye include cyanine dyes described in JP-A Nos. 58-125246, 59-84356, 59-202829, and 60-78787; methine dyes described in JP-A Nos. 58-173696, 58-181690, and 58-194595; naphthoquinone dyes described in JP-A Nos. 58-112793, 58-224793, 59-48187, 59-73996, 60-52940, and 60-63744; squarylium dyes described in JP-A No. 58-112792; and cyanine dyes described in GB Patent No. 434,875.

Other preferable examples of the dye include near infrared absorbing sensitizers described in U.S. Pat. No. 5,156,938; substituted arylbenzo(thio)pyrylium salts described in U.S. Pat. No. 3,881,924; trimethinethiapyrylium salts described in JP-A No. 57-142645 (U.S. Pat. No. 4,327,169); pyrylium type compounds described in JP-A Nos. 58-181051, 58-220143, 59-41363, 59-84248, 59-84249, 59-146063, and 59-146061; cyanine dyes described in JP-A No. 59-216146; pentamethinethiopyrylium salts described in U.S. Pat. No. 4,283,475; and pyrylium compounds described in Japanese Patent Application Publication (JP-B) Nos. 5-13514 and 5-19702.

Additional preferable examples of the dye include near infrared absorbing dyes represented by formulae (I) and (II) as described in U.S. Pat. No. 4,756,993.

Among these dyes, particularly preferable are cyanine dyes, phthalocyanine dyes, oxonol dyes, squarylium dyes, pyrylium salts, thiopyrylium dyes, and nickel thiolate complexes. Dyes represented by the following general formulae (a) to (e) are also preferable since such dyes are excellent in terms of photothermal conversion efficiency. The cyanine dyes represented by the following general formula (a) are most preferable for the following reason: when the dyes are used in the photosensitive composition of the invention, the dyes manifest a high degree of interaction with the alkali-soluble resin, and the dyes are also excellent in terms of stability and economy.

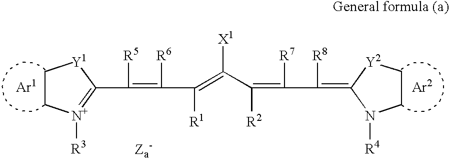

In general formula (a), X¹ represents a hydrogen atom, a halogen atom, —NPh₂, X²-L¹ (wherein X² represents an oxygen atom or a sulfur atom, L¹ represents a hydrocarbon group having 1 to 12 carbon atoms, an aromatic cyclic group having a heteroatom, or a hydrocarbon group containing a heteroatom and having 1 to 12 carbon atoms, and the heteroatom referred to herein is N, S, O, a halogen atom, or Se), or a group represented by the following: 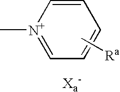
wherein Xa⁻ has the same definition as Za⁻, which will be described at a later time, and R^{a} represents a substituent selected from a hydrogen atom, an alkyl group, an aryl group, a substituted or unsubstituted amino group, or a halogen atom;

R¹ and R² each independently represents a hydrocarbon group having 1 to 12 carbon atoms, and from the viewpoint of the storage stability of the photosensitive composition of the invention when it is used in a coating solution for forming a recording layer of a planographic printing plate precursor, it is preferable that R¹ and R² each independently represents a hydrocarbon group having 2 or more carbon atoms, and more preferably R¹ and R² are bonded to each other to form a 5-membered or 6-membered ring.

Ar¹ and Ar², which may be the same or different, each represent an aromatic hydrocarbon group which may have a substituent. Preferable examples of the aromatic hydrocarbon group include benzene and naphthalene rings. Preferable examples of the substituent include hydrocarbon groups having 12 or less carbon atoms, halogen atoms, and alkoxy groups having 12 or less carbon atoms.
Y¹ and Y², which may be the same or different, each represents a sulfur atom, or a dialkylmethylene group having 12 or less carbon atoms.

R³ and R⁴, which may be the same or different, each represents a hydrocarbon group which has 20 or less carbon atoms and may have a substituent. Preferable examples of the substituent include alkoxy groups having 12 or less carbon atoms, a carboxyl group, and a sulfo group. R⁵, R⁶, R⁷ and R⁸, which may be the same or different, each represents a hydrogen atom, or a hydrocarbon group having 12 or less carbon atoms, and since the raw materials thereof can easily be obtained, each preferably represents a hydrogen atom.

Za⁻ represents a counter anion. However, in a case where the cyanine dye represented by general formula (a) has an anionic substituent in the structure thereof and there is accordingly no need to neutralize electric charges in the dye, Za⁻ is not required. From the viewpoint of the storage stability of the recording layer coating solution, Za⁻ is preferably an ion of a halogen, perchlorate, tetrafluroborate, hexafluorophosphate, or sulfonate. Za⁻ is most preferably an ion of perchlorate, hexafluorophosphate, and arylsulfonic ion.

Specific examples of the cyanine dye represented by general formula (a), and which can be preferably used in the invention, include dyes in JP-A No. 2001-133969 (paragraphs [0017] to [0019]), JP-A No. 2002-40638 (paragraphs [0012] to [0038]), and JP-A No. 2002-23360 (paragraphs [0012] to [0023]), as well as dyes illustrated below.

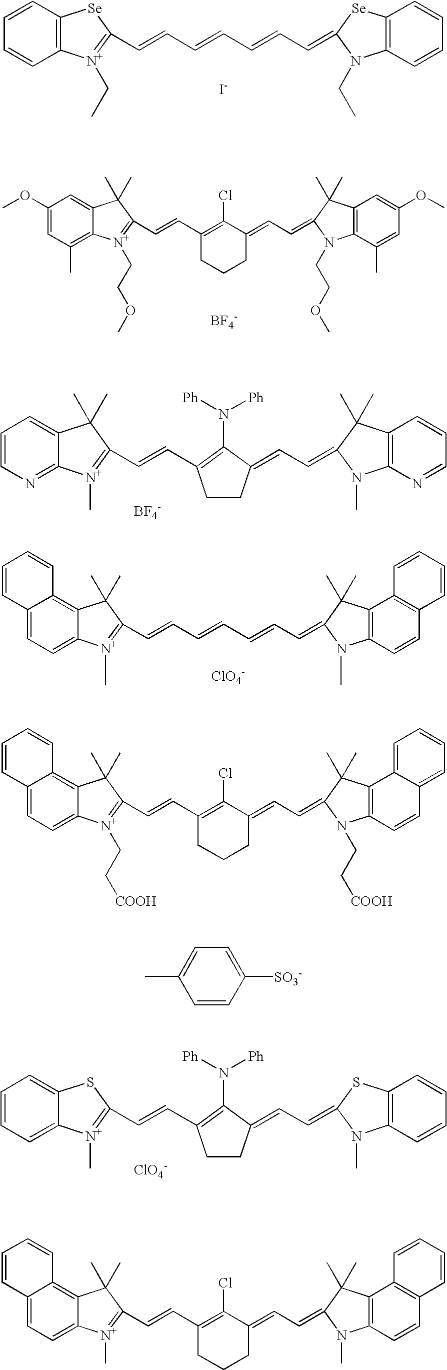

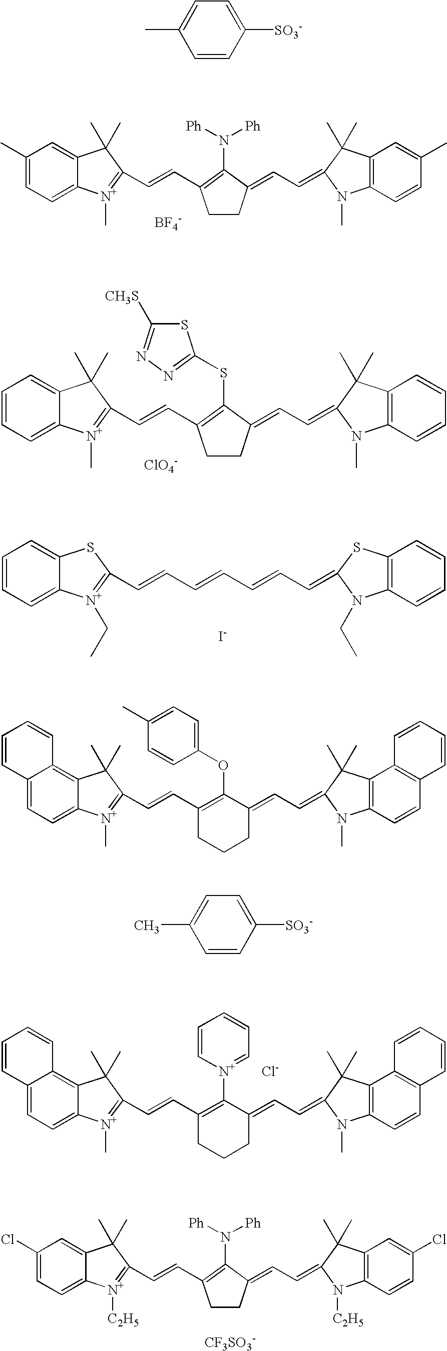

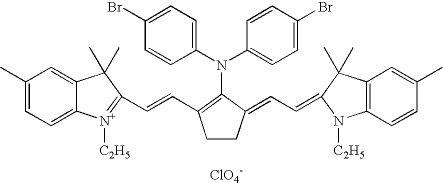

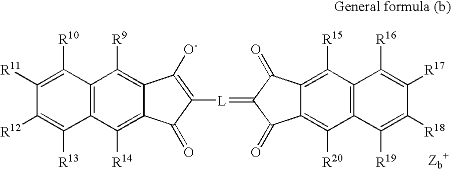

In general formula (b), L represents a methine chain having 7 or more conjugated carbon atoms, and the methine chain may have one or more substituent. The substituents may be bonded to each other to form a cyclic structure. Zb⁺ represents a counter cation. Preferable examples of the counter cation include ammonium, iodonium, sulfonium, phosphonium and pyridinium ions, and alkali metal cations (such as Ni⁺, K⁺ and Li⁺).

R⁹ to R¹⁴ and R¹⁵ to R²⁰ each independently represents a substituent selected from hydrogen atom, halogen atom, and cyano, alkyl, aryl, alkenyl, alkynyl, carbonyl, thio, sulfonyl, sulfinyl, oxy and amino groups; or a substituent obtained by combining two or three from among these substituents. Two or three out of R⁹ to R¹⁴ and R¹⁵ to R²⁰ may be bonded to each other to form a cyclic structure.

A dye wherein L in general formula (b) represents a methine chain having 7 conjugated carbon atoms, and each of R⁹ to R¹⁴ and R¹⁵ to R²⁰ represents a hydrogen atom, is preferable since such a dye can be easily obtained and exhibits advantageous effects.

Specific examples of the dye represented by general formula (b), and which can be preferably used in the invention, are illustrated below.

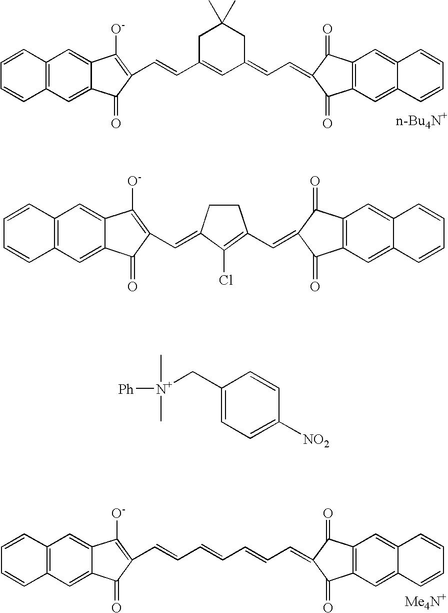

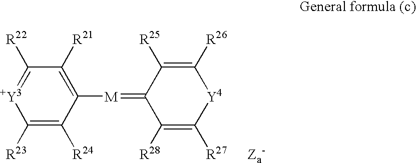

In general formula (c), Y³ and Y⁴ each independently represent an oxygen, sulfur, selenium or tellurium atom; M represents a methine chain having 5 or more conjugated carbon atoms; R²¹ to R²⁴ and R²⁵ to R²⁸, which may be the same or different, each represents a hydrogen or halogen atom, or a cyano, alkyl, aryl, alkenyl, alkynyl, carbonyl, thio, sulfonyl, sulfinyl, oxy or amino group; and Za⁻ represents a counter anion, and has the same meaning as Za⁻ in general formula (a).

Specific examples of the dye which is represented by general formula (c) and which can be preferably used in the invention, are illustrated below.

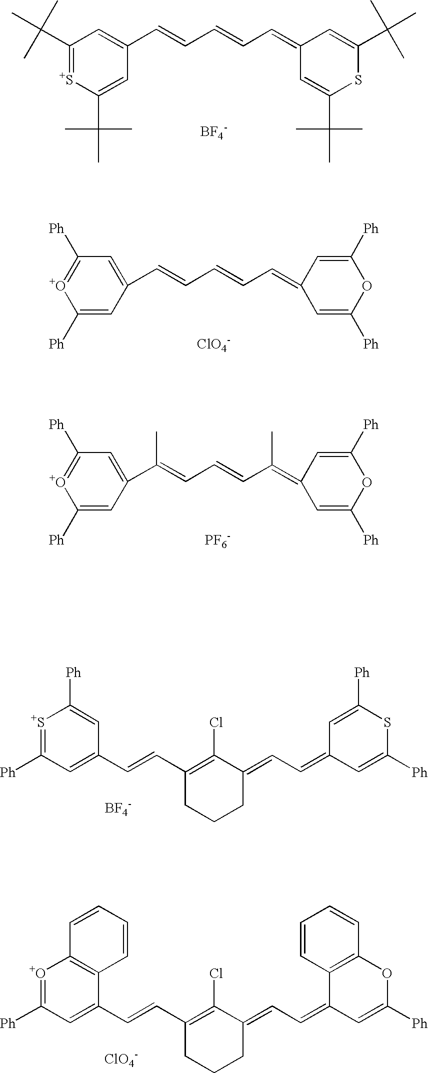

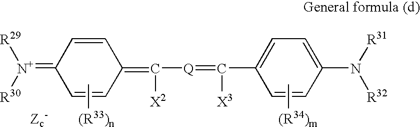

In general formula (d), R²⁹ to R³¹ each independently represents a hydrogen atom, an alkyl group or an aryl group; R³³ and R³⁴ each independently represents an alkyl group, a substituted oxy group, or a halogen atom; n and m each independently represents an integer of 0 to 4; and R²⁹ and R³⁰, or R³¹ and R³² may be bonded to each other to form a ring, or R²⁹ and/or R³⁰ may be bonded to R³³ to form a ring and R³¹ and/or R³² may be bonded to R³⁴ to form a ring. When plural R³³'s and R³⁴'s are present, R³³'s may be bonded to each other to form a ring, or R³⁴'s may be bonded to each other to form a ring.

X² and X³ each independently represents a hydrogen atom, an alkyl group or an aryl group, and at least one of X² and X³ represents a hydrogen atom or an alkyl group.

Q represents a trimethine group or a pentamethine group which may have a substituent, and may be combined with an bivalent linking group to form a cyclic structure. Zc⁻ represents a counter anion and has the same meanings as Za⁻ in general formula (a).

Specific examples of the dye represented by general formula (d) and which can be preferably used in the invention, are illustrated below.

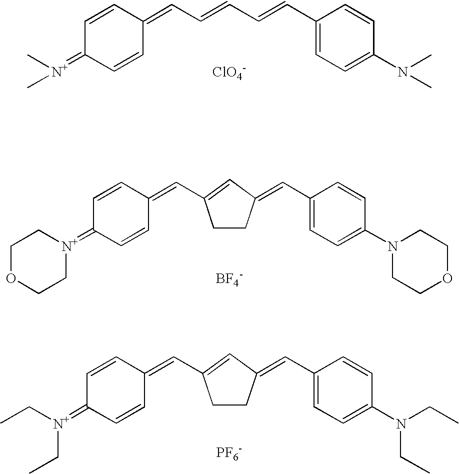

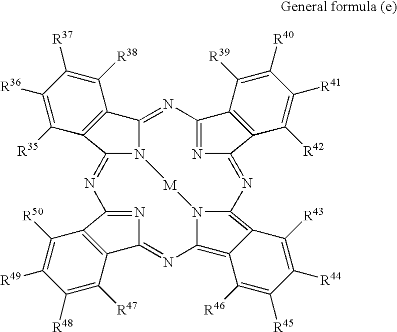

In general formula (e), R³⁵ to R⁵⁰ each independently represents a hydrogen or halogen atom, or a cyano, alkyl, aryl, alkenyl, alkynyl, hydroxyl, carbonyl, thio, sulfonyl, sulfinyl, oxy or amino group, or an onium salt structure, each of which may have a substituent; M represents two hydrogen atoms, a metal atom, a halo metal group, or an oxy metal group. Examples of the metal contained therein include atoms in IA, IIA, IIIB and IVB groups in the periodic table, transition metals in the first, second and third periods therein, and lanthanoid elements. Among these examples, preferable are copper, magnesium, iron, zinc, cobalt, aluminum, titanium, and vanadium.

Specific examples of the dye represented by general formula (e) and which can be preferably used in the invention, are illustrated below.

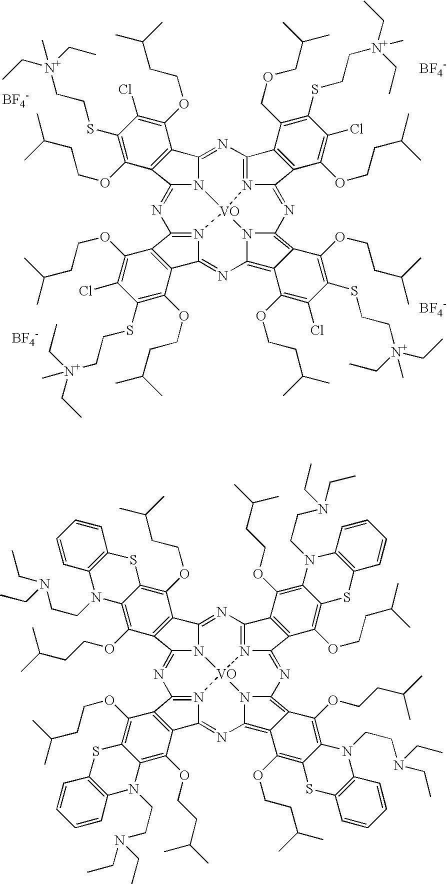

The pigment used as the infrared absorbent in the invention may be a commercially available pigment or a pigment described in publications such as Color Index (C.I.) Handbook, “Latest Pigment Handbook” (edited by Japan Pigment Technique Association, and published in 1977), “Latest Pigment Applied Technique” (by CMC Publishing Co., Ltd. in 1986), and “Printing Ink Technique” (by CMC Publishing Co., Ltd. in 1984).

Examples of the pigment include black pigments, yellow pigments, orange pigments, brown pigments, red pigments, purple pigments, blue pigments, green pigments, fluorescent pigments, metal powder pigments, and polymer-bonded dyes. Specifically, the following can be used: insoluble azo pigments, azo lake pigments, condensed azo pigments, chelate azo pigments, phthalocyanine pigments, anthraquinone pigments, perylene and perynone pigments, thioindigo pigments, quinacridone pigments, dioxazine pigments, isoindolinone pigments, quinophthalone pigments, dyeing lake pigments, azine pigments, nitroso pigments, nitro pigments, natural pigments, fluorescent pigments, inorganic pigments, and carbon black. Among these pigments, carbon black is preferable.

These pigments may be used with or without surface treatment. Examples of surface treatment include a method of coating the surface of the pigments with resin or wax; a method of adhering a surfactant onto the surface; and a method of bonding a reactive material (such as a silane coupling agent, an epoxy compound, or a polyisocyanate) to the pigment surface. The surface treatment methods are described in “Nature and Application of Metal Soap” (Saiwai Shobo), “Printing Ink Technique” (by CMC Publishing Co., Ltd. in 1984). And “Latest Pigment Applied Technique” (by CMC Publishing Co., Ltd. in 1986.

The particle size of the pigment is preferably from 0.01 to 10 μm, more preferably from 0.05 to 1 μm, and even more preferably from 0.1 to 1 μm. When a particle size is within the preferable range, a superior dispersion stability of the pigment in the photosensitive composition can be obtained, whereby, when the photosensitive composition of the invention is used for a recording layer of the photosensitive printing plate precursor, it is possible to form a homogeneous recording layer.

The method for dispersing the pigment may be a known dispersing technique used to produce ink or toner. Examples of a dispersing machine, which can be used, include an ultrasonic disperser, a sand mill, an attriter, a pearl mill, a super mill, a ball mill, an impeller, a disperser, a KD mill, a colloid mill, a dynatron, a three-roll mill, and a pressing kneader. Details are described in “Latest Pigment Applied Technique” (by CMC Publishing Co., Ltd. in 1986).

The pigment or dye as the photothermal conversion substance can be added to the top layer in a ratio of 0.01 to 50%, preferably 0.1 to 40%, and more preferably 0.5 to 30%, relative to the total solid contents which constitute the top layer.

[Other Components]

The photosensitive/heat sensitive layer (recording layer) of the image recording material of the invention may contain a variety of additives, according to necessity, other than the above-mentioned components to the extent that the effects of the invention are not adversely affected.

Examples of the usable additives include so-called dissolution suppressing agents for improving the dissolution inhibiting function of alkaline water-soluble polymers (alkali-soluble resin) in a developer by addition, e.g. onium salts, aromatic sulfonic compounds, aromatic sulfonic acid ester compounds, polyfunctional amine compounds.

It is particularly preferable to add a substance which is thermally decomposable and lowers the solubility of the alkali-soluble resin substantially when not dissolved (i.e., a decomposable dissolution suppressor), such as an onium salt, o-quinonediazide compound or alkyl sulfonate, in terms of enhancing the dissolution-inhibiting function of image portions to the developer. Preferable examples of the decomposable dissolution suppressor include onium salts such as diazonium, iodonium, sulfonium, and ammonium salts; and o-quinonediazide compounds. The diazonium, iodonium, and sulfonium salts are more preferable.

Preferable examples of the onium salt used in the invention include diazonium salts described in S. I. Schlesinger, Photogr. Sci. Eng., 18, 387 (1974), T. S. Bal et al., Polymer, 21, 423 (1980), and JP-A No. 5-158230; ammonium salts described in U.S. Pat. Nos. 4,069,055 and 4,069,056, and JP-A No. 3-140140; phosphonium salts described in D. C. Necker et al., Macromolecules, 17, 2468 (1984), C. S. Wen et al., Teh, Proc. Conf. Rad. Curing ASIA, p478 Tokyo, October (1988), and U.S. Pat. Nos. 4,069,055 and 4,069,056; iodonium salts described in J. V. Crivello et al., Macromolecules, 10 (6), 1307 (1977), Chem. & Eng. News, Nov. 28, p31 (1988), EP No. 104,143, U.S. Pat. Nos. 5,041,358 and 4,491,628, and JP-A Nos. 2-150848 and 2-296514; sulfonium salts described in J. V. Crivello et al., Polymer J. 17, 73 (1985), J. V. Crivello et al., J. Org. Chem., 43, 3055 (1978), W. R. Watt et al., J. Polymer Sci., Polymer Chem. Ed., 22, 1789 (1984), J. V. Crivello et al., Polymer Bull., 14, 279 (1985), J. V. Crivello et al., Macromolecules, 14 (5), 1141 (1981), J. V. Crivello et al., J. Polymer Sci., Polymer Chem. Ed., 17, 2877 (1979), EP Nos. 370,693, 233,567, 297,443 and 297,442, U.S. Pat. Nos. 4,933,377, 3,902,114, 5,041,358, 4,491,628, 4,760,013, 4,734,444 and 2,833,827, and DE Pat. Nos. 2,904,626, 3,604,580 and 3,604,581; selenonium salts described in J. V. Crivello et al., Macromolecules, 10 (6), 1307 (1977), J. V. Crivello et al., J. Polymer Sci., Polymer Chem. Ed., 17, 1047 (1979); arsonium salts described in C. S. Wen et al., and The Proc. Conf. Rad. Curing ASIA, p478, Tokyo, October (1988).

Among such onium salts, diazonium salts are particularly preferable from the viewpoints of both their capacity of hindering dissolution, and their thermal decomposability. The diazonium salts represented by general formula (I) in the JP-A No. 5-158230 and the diazonium salts represented by general formula (1) in JP-A No. 11-143064 are more preferable, and diazonium salts represented by general formula (1) in the JP-A No. 11-143064, which have low absorption wavelength peaks within the visible ray range, are most preferable.

Examples of the counter ion of the onium salt include tetrafluoroboric acid, hexafluorophosphoric acid, triisopropylnaphthalenesulfonic acid, 5-nitro-o-toluenesulfonic acid, 5-sulfosalicylic acid, 2,5-dimethylbenzenesulfonic acid, 2,4,6-trimethylbenzenesulfonic acid, 2-nitrobenzenesulfonic acid, 3-chlorobenzenesulfonic acid, 3-bromobenzenesulfonic acid, 2-fluorocaprylnaphthalenesulfonic acid, dodecylbenzenesulfonic acid, 1-naphthol-5-sulfonic acid, 2-methoxy-4-hydroxy-5-benzoyl-benzenesulfonic acid, and p-toluenesulfonic acid. Among these examples, hexafluorophosphoric acid, and alkylaromatic sulfonic acids such as triisopropylnaphthalenesulfonic acid and 2,5-dimethylbezenesulfonic acid are particularly preferable.

The quinonediazide is preferably an o-quinonediazide compound. The o-quinonediazide compound used in the invention is a compound having at least one o-quinonediazide group and having an alkali-solubility increased by being thermally decomposed. The compound may be any one of compounds having various structures.

In other words, the o-quinonediazide compound assists the solubility of the photosensitive material both from the viewpoint of the effects of being thermally decomposed, and thereby losing the function of suppressing the dissolution of the binder, and the effect that the o-quinonediazide itself is changed into an alkali-soluble material.

Preferable examples of the o-quinonediazide compound used in the invention include compounds described in J. Coser, “Light-Sensitive Systems” (John Wiley & Sons. Inc.), pp. 339-352. Particularly preferable are sulfonic acid esters or sulfonamides of o-quinonediazide made to react with various aromatic polyhydroxy compounds or with aromatic amino compounds.

Further preferable examples include an ester made from benzoquinone-(1,2)-diazidesulfonic acid chloride or naphthoquinone-(1,2)-diazide-5-sulfonic acid chloride and pyrogallol-acetone resin, as described in JP-B No. 43-28403; and an ester made from benzoquinone-(1,2)-diazidesulfonic acid chloride or naphthoquinone-(1,2)-diazide-5-sulfonic acid chloride and phenol-formaldehyde resin.

Additional preferable examples include an ester made from naphthoquinone-(1,2)-diazide-4-sulfonic acid chloride and phenol-formaldehyde resin or cresol-formaldehyde resin; and an ester made from naphthoquinone-(1,2)-diazide-4-sulfonic acid chloride and pyrogallol-acetone resin.

Other useful o-quinonediazide compounds are reported in unexamined or examined patent documents, examples of which include JP-A Nos. 47-5303, 48-63802, 48-63803, 48-96575, 49-38701 and 48-13354, JP-B No. 41-11222,45-9610 and 49-17481, U.S. Pat. Nos. 2,797,213, 3,454,400, 3,544,323, 3,573,917, 3,674,495 and 3,785,825, GB Patent Nos. 1,227,602, 1,251,345, 1,267,005, 1,329,888 and 1,330,932, and DE Pat. No. 854,890.

The amount of onium salt and/or o-quinonediazide compound added as the decomposable dissolution suppresser(s) is preferably from 1 to 10%, more preferably from 1 to 5%, and even more preferably from 1 to 2% by relative to the total solid contents of the recording layer. The onium salts and the o-quinonediazide compounds may be used either independently or in the form of mixtures of two or more thereof.

The amount of additives other than the o-quinonediazide compound added is preferably from 0.1 to 5%, more preferably from 0.1 to 2%, and even more preferably from 0.1 to 1.5% by mass. The additives and the binder used in the invention are preferably incorporated into the same layer.

A dissolution suppresser having no decomposability may be used in combination. Preferable examples thereof include sulfonic acid esters, phosphoric acid esters, aromatic carboxylic acid esters, aromatic disulfones, carboxylic acid anhydrides, aromatic ketones, aromatic aldehydes, aromatic amines, and aromatic ethers, details of which are described in JP-A No. 10-268512; acidic color-developable dyes which have a lactone skeleton, an N,N-diarylamide skeleton or a diarylmethylimino skeleton and also function as a coloring agent, details of which are described in JP-A No. 11-190903; and nonionic surfactants described, details of which are described in JP-A No. 2000-105454.

In order to enhance sensitivity, the photosensitive composition may also contain a cyclic acid anhydride, a phenolic compound, or an organic acid.

Examples of cyclic acid anhydride include phthalic anhydride, tetrahydrophthalic anhydride, hexahydrophthalic anhydride, 3,6-endooxy-Δ4-tetrahydrophthalic anhydride, tetrachlorophthalic anhydride, maleic anhydride, chloromaleic anhydride, α-phenylmaleic anhydride, succinic anhydride, and pyromellitic anhydride which are described in U.S. Pat. No. 4,115,128.

Examples of phenolic compound include bisphenol A, p-nitrophenol, p-ethoxyphenol, 2,4,4′-trihydroxybenzophenone, 2,3,4-trihydroxybenzophenone, 4-hydroxybenzophenone, 4,4′,4″-trihydroxytriphenylmethane, 4,4′,3″,4″-tetrahydroxy-3,5,3′,5′-tetramethyltriphenylmethane.

Examples of the organic acid include sulfonic acids, sulfonic acids, alkylsulfuric acids, phosphonic acids, phosphates, and carboxylic acids, which are described in JP-A No. 60-88942 or 2-96755. Specific examples thereof include p-toluenesulfonic acid, dodecylbenzenesulfonic acid, p-toluenesulfinic acid, ethylsulfuric acid, phenylphosphonic acid, phenylphosphinic acid, phenyl phosphate, diphenyl phosphate, benzoic acid, isophthalic acid, adipic acid, p-toluic acid, 3,4-dimethoxybenzoic acid, phthalic acid, terephthalic acid, 4-cyclohexene-1,2-dicarboxylic acid, erucic acid, lauric acid, n-undecanoic acid, and ascorbic acid.

When the cyclic acid anhydride, the phenol or the organic acid is added to a recording layer of a planographic printing plate precursor, the ratio thereof in the recording layer is preferably from 0.05 to 20%, more preferably from 0.1 to 15%, and even more preferably from 0.1 to 10% by mass.

Besides the above-mentioned agents, epoxy compounds, vinyl ethers, and phenol compounds having hydroxymethyl groups as described in Japanese Patent Application Laid-Open No. 8-276558, phenol compounds having alkoxymethyl group and crosslinking compounds having the function of inhibiting dissolution in alkaline solution as described in Japanese Patent Application Laid-Open No. 11-160860 proposed by inventors may be added.

When the recording layer according to the invention is formed, in order to enhance stability in processes which are affected by developing conditions, the following can be added to the coating solution therefor: nonionic surfactants as described in JP-A Nos. 62-251740 and 3-208514; amphoteric surfactants as described in JP-A Nos. 59-121044 and 4-13149; siloxane compounds as described in EP No. 950517; and copolymers made from a fluorine-containing monomer as described in JP-A No. 1.1-288093.

Specific examples of nonionic surfactants include sorbitan tristearate, sorbitan monopalmitate, sorbitan trioleate, monoglyceride stearate, and polyoxyethylene nonyl phenyl ether. Specific examples of amphoteric surfactants include alkyldi(aminoethyl)glycine, alkylpolyaminoethylglycine hydrochloride, 2-alkyl-N-carboxyethyl-N-hydroxyethylimidazolinium betaine and N-tetradecyl-N,N′-betaine type surfactants (trade name: “Amolgen K”, manufactured by Dai-ichi Kogyo Seiyaku Co., Ltd.).

The siloxane compounds are preferably block copolymers made from dimethylsiloxane and polyalkylene oxide. Specific examples thereof include polyalkylene oxide modified silicones (trade names: DBE-224, DBE-621, DBE-712, DBE-732, and DBE-534, manufactured by Chisso Corporation; trade name: Tego Glide 100, manufactured by Tego Co., Ltd.).

The content of the nonionic surfactant and/or the amphoteric surfactant in the photosensitive composition is preferably from 0.05 to 15% by mass, and more preferably from 0.1 to 5% by mass.

To the photosensitive composition of the invention may be added a printing-out agent for obtaining a visible image immediately after the photosensitive composition of the invention has been heated by exposure to light, or a dye or pigment as an image coloring agent.

A typical example of a printing-out agent is a combination of a compound which is heated by exposure to light, thereby emitting an acid (an optically acid-generating agent), and an organic dye which can form salts (salt formable organic dye).

Specific examples thereof include combinations of an o-naphthoquinonediazide-4-sulfonic acid halogenide with a salt-formable organic dye, described in JP-A Nos. 50-36209 and 53-8128; and combinations of a trihalomethyl compound with a salt-formable organic dye, described in each of JP-A Nos. 53-36223, 54-74728, 60-3626, 61-143748, 61-151644 and 63-58440.

The trihalomethyl compound is classified into an oxazol compound or a triazine compound. Both of the compounds provide excellent in stability over the passage of time and produce a vivid printed-out image.

As the image coloring agent, a dye different from the above-mentioned salt-formable organic dye may be used. Preferable examples of such a dye, and of the salt-formable organic dye, include oil-soluble dyes and basic dyes.

Specific examples thereof include Oil yellow # 101, Oil Yellow # 103, Oil Pink #312, Oil Green BG, Oil Blue BOS, Oil Blue #603, Oil Black BY, Oil Black BS, and Oil Black T-505 (each of which is manufactured by Orient Chemical Industries Ltd.); Victoria Pure Blue, Crystal Violet (CI42555), Methyl Violet (CI42535), Ethyl Violet, Rhodamine B (CI145170B), Malachite Green (CI42000), and Methylene Blue (CI52015).

Dyes described in JP-A No. 62-293247 are particularly preferable. These dyes may be added to the photosensitive composition at a ratio of 0.01 to 10% by mass, and preferably 0.1 to 3% by mass, relative to the total solid contents therein.

Whenever necessary, a plasticizer may be added to the photosensitive composition of the invention to give flexibility to a coating film made from the composition. Examples of the plasticizer include oligomers and polymers of butyl phthalyl, polyethylene glycol, tributyl citrate, diethyl phthalate, dibutyl phthalate, dihexyl phthalate, dioctyl phthalate, tricresyl phosphate, tributyl phosphate, trioctyl phosphate, tetrahydrofurfuryl olete, and acrylic acid and methacrylic acid.

[Formation of Image Recording Material]

In order to form the image recording material of the invention, a recording material layer coating solution, wherein each component to be contained in the above-mentioned recording layer (upper and lower layers) is dissolved in a solvent, is applied onto an appropriate support. As described above, it is essential that the specific polymer, which is a characteristic component of the invention, is contained in the lower layer. The specific polymer may be contained in both of the upper and lower layers.

The image recording material of the invention may further comprise a protection layer, an undercoat layer, and a back coat layer described below, depending on the purpose, other than the recording layers.

The solvents to be used in such cases may be ethylene dichloride, cyclohexanone, methyl ethyl ketone, methanol, ethanol, propanol, ethylene glycol monomethyl ether, 1-methoxy-2-propanol, 2-methoxyethyl acetate, 1-methoxy-2-propyl acetate, dimethoxyethane, methyl lactate, ethyl lactate, N,N-dimethylacetamide, N,N-dimethylformamide, tetramethylurea, N-methylpyrrolidone, dimethyl sulfoxide, sulfolane, γ-butyrolactone, and toluene, however the solvents should not be limited to these examples. These solvents may be used alone or in form of mixtures.

The concentration of the above-mentioned components (the solid components including the additives) in the solvent is preferable 1 to 50% by weight.

A variety of methods as the coating method can be employed, and bar coater coating, spin coating, spray coating, curtain coating, dip coating, air knife coating, blade coating, and roll coating can be exemplified.

The (solid-content) applied amount of the recording layer, on the support, obtained by the application and drying of the coating solution, is varied in accordance with the use purpose of the recording layer. In the case that the recording material is used as a planographic printing plate precursor, the amount of the lower layer components applied onto the support and dried is preferably from 0.05 to 1.5 g/m², and more preferably from 0.1 to 1.0 g/m². When the amount is in this range, a superior printing resistance improving effect and a good image reproducibility can be attained. Additionally, high-sensitivity recording can be attained.

The amount of the applied and dried upper layer components is preferably from 0.05 to 3.5 g/m², and more preferably from 0.1 to 1.5 g/m². When the amount is in this preferred range, high-sensitivity recording can be attained and, further, a superior printing resistance-improving effect can be obtained.

The total amount of the applied and dried upper and lower layers is preferably from 0.5 to 5.0 g/m², and more preferably from 1.0 to 3.0 g/m².

In principle, the upper and lower layers are preferably formed separately from each other.

Examples of the method for the separate formation of the two layers include a method of using a difference in solvent-solubility between the components contained in the upper and lower layers, and a method of applying the upper layer and subsequently drying and removing the solvent rapidly.

The coating solutions for the recording layers of the invention may contain a surfactant for improving the coatability, for example fluorine type surfactants described in Japanese Patent Application Laid-Open No. 62-170950. The addition amount is preferably 0.01 to 1% by weight and more preferably 0.05 to 0.5% by weight in the total solid components in the recording layer.

[Support]

The support used in the planographic printing plate precursor is a plate having dimensional stability. A plate satisfying required physical properties such as strength and flexibility can be used without any restriction. Examples thereof include paper, plastic (such as polyethylene, polypropylene or polystyrene)-laminated papers, metal plates (such as aluminum, zinc and copper plates), plastic films (such as cellulose biacetate, cellulose triacetate, cellulose propionate, cellulose lactate, cellulose acetate lactate, cellulose nitrate, polyethylene terephthalate, polyethylene, polystyrene, polypropylene, polycarbonate, and polyvinyl acetate films), and papers or plastic films on which, as described above, a metal is laminated or vapor-deposited.

The support is preferably a polyester film or an aluminum plate, and more preferably an aluminum plate, since an aluminum plate is superior in terms of dimensional stability and is also relatively inexpensive.

Preferable examples of the aluminum plate include a pure aluminum plate and alloy plates made of aluminum as a main component with a very small amount of other elements. A plastic film on which aluminum is laminated or vapor-deposited may also be used.

Examples of other elements contained in the aluminum alloys include silicon, iron, manganese, copper, magnesium, chromium, zinc, bismuth, nickel, and titanium. The content by percentage of different elements in the alloy is at most 10% by mass. A particularly preferable aluminum plate in the invention is a pure aluminum plate; however, since from the viewpoint of refining a completely pure aluminum cannot be easily produced, a very small amount of other elements may also be contained in the plate.

The aluminum plate used as the support is not specified in terms of the composition thereof. Thus, aluminum plates which are conventionally known can be appropriately used. The thickness of the aluminum plate used in the invention is from about 0.1 to 0.6 mm, preferably from 0.15 to 0.4 mm, and more preferably from 0.2 to 0.3 mm.

If necessary, prior to the surface-roughening treatment, the aluminum plate may optionally be subjected to degreasing treatment, in order to remove rolling oil or the like on the surface, with a surfactant, an organic solvent, an aqueous alkaline solution or the like.

The surface-roughening treatment of the aluminum surface can be performed by various methods such as a mechanical surface-roughening method, a method of dissolving and roughening the surface electrochemically, and a method of dissolving the surface selectively in a chemical manner.

Mechanical surface-roughening methods which can be used may be known methods, such as a ball polishing method, a brush polishing method, a blast polishing method or a buff polishing method. An electrochemical surface-roughening method may be a method of performing surface-roughening in an electrolyte of hydrochloric acid or nitric acid, by use of an alternating current or a direct current. As disclosed in JP-A No. 54-63902, a combination of the two kinds of methods may be used.

An aluminum plate whose surface is roughened as described above is if necessary subjected to alkali-etching treatment and neutralizing treatment. Thereafter, an anodizing treatment is optionally applied in order to improve the water holding capacity and wear resistance of the surface.

The electrolyte used in the anodizing treatment of the aluminum plate is any one selected from various electrolytes which can form a porous oxide film. Among which in general use are electrolytes of sulfuric acid, phosphoric acid, oxalic acid, chromic acid, or a mixed acid thereof. The concentration of the electrolyte may be appropriately decided depending on the kind of electrolyte selected.

Treatment conditions for anodization cannot be specified as a general rule since conditions vary depending on the electrolyte used; however, the following range of conditions are generally suitable: an electrolyte concentration of 1 to 80% by mass, a solution temperature of 5 to 70° C., a current density of 5 to 60 A/dm², a voltage of 1 to 100 V, and an electrolyzing time of 10 seconds to 5 minutes. If the amount of anodic oxide film is less than 1.0 g/m², printing resistance is inadequate or non-image portions of the planographic printing plate tend to become easily damaged and the so-called “blemish stains”, resulting from ink adhering to damaged portions at the time of printing, are easily generated.

After the anodizing treatment, the surface of the aluminum is if necessary subjected to treatment for obtaining hydrophilicity. This securance of hydrophilicity treatment may be an alkali metal silicate (for example, an aqueous sodium silicate solution) method, as disclosed in U.S. Pat. Nos. 2,714,066, 3,181,461, 3,280,734, and 3,902,734. In this method, the support is subjected to an immersing treatment or an electrolyzing treatment with an aqueous sodium silicate solution.

In addition, the following methods may also be used: a method of treating the support with potassium fluorozirconate, as disclosed in JP-B No. 36-22063, or with polyvinyl phosphonic acid, as disclosed in U.S. Pat. Nos. 3,276,868, 4,153,461, and 4,689,272.

The planographic printing plate precursor to which the invention is applied is a precursor wherein a positive type recording layer is formed on a support. If necessary, an undercoat layer may be formed therebetween.

As components of the undercoat layer, various organic compounds can be used. Examples thereof include carboxymethylcellulose, dextrin, gum arabic, phosphonic acids having an amino group, such as 2-aminoethylphosphonic acid, organic phosphonic acids which may have a substituent, such as phenyl phosphonic acid, naphthylphosphonic acid, alkylphosphonic acid, glycerophosphonic acid, methylenediphosphonic acid and ethylenediphosphonic acid, organic phosphoric acids which may have a substituent, such as phenylphosphoric acid, naphthylphosphoric acid, alkylphosphoric acid and glycerophosphoric acid, organic phosphinic acids which may have a substituent, such as phenylphosphinic acid, naphthylphosphinic acid, alkylphosphinic acid and glycerophosphinic acid, amino acids such as glycine and β-alanine, and hydrochlorides of amines having a hydroxyl group, such as a hydrochloride of triethanolamine. These organic compounds may be used alone or in the form of a mixture made up of two or more thereof.

This organic undercoat layer may be formed by methods which can be described as follows: a method of applying onto the aluminum plate a solution wherein the above-mentioned organic compound is dissolved in water, or an organic solvent such as methanol, ethanol or methyl ethyl ketone, or a mixed solvent thereof and then drying the resultant aluminum plate, or a method of immersing the aluminum plate into a solution wherein the above-mentioned organic compound is dissolved in water, or an organic solvent such as methanol, ethanol or methyl ethyl ketone, or a mixed solvent thereof so as to adsorb the compound, washing the aluminum plate with water or the like, and then drying the resultant aluminum plate.

In the former method, the solution of the organic compound having a concentration of 0.005 to 10% by mass may be applied in various ways. In the latter method, the concentration of the organic compound in the solution is from 0.01 to 20%, preferably from 0.05 to 5%, the temperature for the immersion is from 20 to 90° C., preferably from 25 to 50° C., and the time taken for immersion is from 0.1 second to 20 minutes, preferably from 2 seconds to 1 minute.

The pH of the solution used in the above-mentioned methods can be adjusted into a range of 1 to 12 with a basic material such as ammonia, triethylamine or potassium hydroxide, or an acidic material such as hydrochloric acid or phosphoric acid. Moreover, a yellow dye may be added to the solution, in order to improve the tone reproducibility of the recording layer.

The amount of organic undercoat layer applied is suitably from 2 to 200 mg/m², preferably from 5 to 100 mg/m². When the amount applied is within the aforementioned ranges, a good effect of enhancing printing durability can be obtained.

The image recording material of the invention produced in above manner is used preferably for a planographic printing plate precursor and generally subjected to imagewise exposure and development. Hereinafter, an image recording method in the case of using the image recording material of the invention for a planographic printing plate precursor will be described.

As an exposure condition, the exposure light energy density is preferably higher than 5 kW/cm² to 10 kW/cm² in terms of the effective utilization of the heat in the image formation, and by exposure under such a condition, desirable sensitivity can be achieved. The higher the exposure energy density is, the more advantageous in terms of the sensitivity. However, in the case the exposure power density exceeds 50 kW/cm², abrasion is easily caused, which sometimes results in a trouble such as stains in optical system.

With respect to the exposure light wavelength, presently, from the viewpoint of an economic efficiency of high power laser, it is preferable to use laser in a range from near infrared rays to infrared rays. As an exposure light source, solid laser, semiconductor laser are preferable in terms of the economic efficiency and the life of the light source.

As the developer and replenisher for the planographic printing plate of the invention, aqueous solutions of a conventional alkali agent can be used.

Examples of the alkali agent include inorganic alkali salts such as sodium silicate, potassium silicate, trisodium phosphate, tripotassium phosphate, triammonium phosphate, disodium hydrogenphosphate, dipotassium hydrogenphosphate, diammonium hydrogenphosphate, sodium carbonate, potassium carbonate, ammonium carbonate, sodium hydrogencarbonate, potassium hydrogencarbonate, ammonium hydrogen carbonate, sodium borate, potassium borate, ammonium borate, sodium hydroxide, ammonium hydroxide, potassium hydroxide and lithium hydroxide; and organic alkali agents such as monomethylamine, dimethylamine, trimethylamine, monoethylamine, diethylamine, triethylamine, monoisopropylamine, diisopropylamine, triisopropylamine, n-butylamine, monoethanolamine, diethanolamine, triethanolamine, monoisopropanolamine, diisopropanolamine, ethyleneimine, ethylenediamine, and pyridine. These alkali agents may be used alone or in combinations of two or more thereof.

Among these alkali agents, silicates such as sodium silicate and potassium silicate are particularly preferable for the developer. This is because the developing capacity of the developer can be controlled by adjusting the ratio between silicon oxide (SiO₂) and alkali metal oxide (M₂O), which are components of any one of the silicates, and by adjusting the concentrations thereof. For example, alkali metal silicates as described in JP-A No. 54-62004 or JP-B No. 57-7427 can be effectively used.

In a case where an automatic developing machine is used to perform development, an aqueous solution having a higher alkali intensity than that of the developer (or, replenisher) can be added to the developer. It is known that this makes it possible to treat a great number of photosensitive plates without recourse to replacing the developer in the developing tank over a long period of time. This replenishing manner is also preferably used in the invention.

If necessary, various surfactants or organic solvents can be incorporated into the developer and the replenisher in order to promote and suppress development capacity, disperse development scum, and enhance the ink-affinity of image portions of the printing plate.

Preferable examples of the surfactant include anionic, cationic, nonionic and amphoteric surfactants. If necessary, the following may be added to the developer and the replenisher: a reducing agent (such as hydroquinone, resorcin, a sodium or potassium salt of an inorganic acid such as sulfurous acid or hydrogen sulfite acid), an organic carboxylic acid, an antifoaming agent, and a water softener.

The printing plate developed with the developer and replenisher described above is subsequently subjected to treatments with washing water, a rinse solution containing a surfactant and other components, and a desensitizing solution containing gum arabic and a starch derivative. For after treatment following use of the photosensitive composition of the invention as a planographic printing plate precursor, various combinations of these treatments may be employed.

In recent years, automatic developing machines for printing plate precursors have been widely used in order to rationalize and standardize plate-making processes in the plate-making and printing industries. These automatic developing machines are generally made up of a developing section and a post-processing section, and include a device for carrying printing plate precursors, various treating solution tanks, and spray devices. These machines are machines for spraying respective treating solutions, which are pumped up, onto an exposed printing plate through spray nozzles, for development, while the printing plate is transported horizontally.

Recently, a method has also attracted attention in which a printing plate precursor is immersed in treating solution tanks filled with treating solutions and conveyed by means of in-liquid guide rolls. Such automatic processing can be performed while replenishers are being replenished into the respective treating solutions in accordance with the amounts to be treated, operating times, and other factors.

A so-called use-and-dispose processing manner can also be used, in which treatments are conducted with treating solutions which in practice have yet been used.

In cases where unnecessary image portions (for example, a film edge mark of an original picture film) are present on a planographic printing plate obtained by exposing imagewise to light a planographic printing plate precursor to which the invention is applied, developing the exposed precursor, and subjecting the developed precursor to water-washing and/or rinsing and/or desensitizing treatment(s), unnecessary image portions can be erased.

The erasing is preferably performed by applying an erasing solution to unnecessary image portions, leaving the printing plate as it is for a given time, and washing the plate with water, as described in, for example, JP-B No. 2-13293. This erasing may also be performed by a method of radiating active rays introduced through an optical fiber onto the unnecessary image portions, and then developing the plate, as described in JP-A No. 59-174842.

The planographic printing plate obtained as described above is, if desired, coated with a desensitizing gum, and subsequently the plate can be made available for a printing step. When it is desired to make a planographic printing plate have a higher degree of printing resistance, baking treatment is applied to the planographic printing plate.

In a case where the planographic printing plate is subjected to the baking treatment, it is preferable that before the baking treatment takes place the plate is treated with a surface-adjusting solution as described in JP-B No. 61-2518, or JP-A Nos. 55-28062, 62-31859 or 61-159655.

This method of treatment is, for example, a method of applying the surface-adjusting solution onto the planographic printing plate with a sponge or absorbent cotton infiltrated with the solution, a method of immersing the planographic printing plate in a vat filled with the surface-adjusting solution, or a method of applying the surface-adjusting solution to the planographic printing plate with an automatic coater. In a case where after application the amount of solution applied is made uniform with a squeegee or a squeegee roller, a better result can be obtained.

In general, the amount of surface-adjusting solution applied is suitably from 0.03 to 0.8 g/m² (dry mass). If necessary the planographic printing plate onto which the surface-adjusting solution is applied can be dried, and then the plate is heated to a high temperature by means of a baking processor (for example, a baking processor (BP-1300) sold by Fuji Photo Film Co., Ltd.) or the like. In this case the heating temperature and the heating time, which depend on the kind of components forming the image, are preferably from 180 to 300° C. and from 1 to 20 minutes, respectively. By means of this treatment, the recording layer related to the invention can manifest a superior baking printing resistance.

If necessary, a planographic printing plate subjected to baking treatment can be subjected to treatments which have been conventionally conducted, such as a water-washing treatment and gum coating. However, in a case where a surface-adjusting solution containing a water soluble polymer compound or the like is used, the so-called desensitizing treatment (for example, gum coating) can be omitted. The planographic printing plate obtained as a result of such treatments is applied to an offset printing machine or to some other printing machine, and is used for printing on a great number of sheets.

### EXAMPLES

Hereinafter, the present invention will be described in more details along with Examples, however the invention is not limited to these Examples. In the Examples, image recording materials of the invention were evaluated by being used as planographic printing plate precursors. These evaluations were used as evaluations of the image recording materials of the invention.

[Production of Supporting Bodies]

A support is produced by treating JIS-A-1050 aluminum sheets with 0.3 mm thickness by a combination of the following processes.

(a) Mechanical Surface Roughening Treatment

While a suspension containing a polishing agent (silica sand) with a specific gravity of 1.12 and water is supplied as a polishing slurry to a surface of each aluminum sheet, and mechanical surface roughening is carried out by rotating roller type nylon brushes. The average particle size of the polishing agent is 8 μm and maximum particle size 50 μm. The material of the nylon brushes is 6-10 nylon and hair length and hair diameters are 50 mm and 0.3 mm, respectively. The nylon brushes are produced by implanting the hairs densely in holes formed in stainless cylinders with a diameter of 300 mm. Three rotating brushes are used. Two supporting rollers (200 mm diameter) are placed below the brushes with a separation of 300 mm. The brush rollers are pushed until the load of the driving motor for rotating the brushes is increased by 7 kW or more from the load before pushing the brush rollers against the aluminum sheet. The rotation direction of the brushes is the same as the moving direction of the aluminum sheet. The rotation speed of the brushes is 200 rpm.

(b) Alkaline Etching Treatment

Etching treatment is carried out by spraying an aqueous NaOH solution (concentration 26% by weight and an aluminum ion concentration 6.5% by weight) at 70° C. to the obtained aluminum sheet in order to dissolve an amount of 6 g/m² aluminum sheet. After that, the aluminum sheet is washed with water by spraying.

(c) Desmut Treatment

Desmut treatment is carried out by spraying an aqueous solution of 1% by weight nitric acid (containing an aluminum ion concentration of 0.5% by weight) at 30° C. and then the resulting aluminum sheet is washed with water. As the aqueous nitric acid solution used for desmut, waste solution from a process of electrochemical surface roughening in an aqueous nitric acid solution by AC (alternate current) can be used.

(d) Electrochemical Surface Roughening Treatment

Electrochemical surface roughening treatment can be carried out continuously by using 60 Hz AC voltage. The electrolytic solution used in this case is an aqueous solution of nitric acid 10.5 g/L (aluminum ion 5 g/L) at 50° C. The electrochemical surface roughening can be carried out using an AC power waveform which is a trapezoidal rectangular waveform, with the time TP from a zero current value to a peak being 0.8 msec and Duty ratio 1:1, and employing a carbon electrode as an opposed electrode. Ferrite is used as an auxiliary anode. A radial cell type electrolytic bath is used.

The current density is 30 A/dm² at the peak value of the current and the total electricity quantity is 220 C./dm² when aluminum sheet is used as an anode. Five percent of the electric current flowing from the electric power was shunted through the auxiliary anode.

After that, the resulting aluminum sheet is washed with a water spray.

(e) Alkali Etching Treatment

Etching treatment can be carried out on the aluminum sheet at 32° C. by spraying a solution with sodium hydroxide concentration 26% by weight and aluminum ion concentration 6.5% by weight. By doing this 0.2-3.0 g/m² of the aluminum sheet is dissolved so as to remove the smut component of mainly aluminum hydroxide produced when carrying out the electrochemical surface roughening by using alternating current in the prior step. It also has the effect of dissolving the edge parts of formed pits so as to smooth the edge parts. After that, the aluminum sheet is washed by water spray.

(f) Desmut treatment

Desmut treatment is carried out by spraying an aqueous solution of 15% by weight nitric acid (containing aluminum ion 4.5% by weight) at 30° C. and then the resulting aluminum sheet is washed by water spray. For the aqueous nitric acid solution used for the desmut, waste solution from the process of electrochemical surface roughening in an aqueous nitric acid solution by AC can be used.

(g) Electrochemical Surface Roughening Treatment

Electrochemical surface roughening treatment can be carried out continuously by using 60 Hz AC voltage. The electrolytic solution used in this case is an aqueous solution of hydrochloric acid 7.5 g/L (containing aluminum ion 5 g/L) at 35° C. The AC power waveform is a rectangular waveform and a carbon electrode is used as an opposed electrode for the electrochemical surface roughening treatment. Ferrite is used as an auxiliary anode. A radial cell type electrolytic bath was used.

The current density is 25 A/dm² at the peak value of the current and the total electricity quantity was 50 C./dm² when aluminum sheet is used as an anode.

After that, the resulting aluminum sheet is washed with a water spray.

(h) Alkali Etching Treatment

Etching treatment is carried out at 32° C. for aluminum sheet by spraying a solution, of sodium hydroxide concentration 26% by weight and aluminum ion concentration 6.5% by weight, to dissolve 0.10 g/m² of the aluminum sheet. This removes the smut, of which the main is component aluminum hydroxide, produced when the electrochemical surface is roughened by using alternating current in the prior step. Also it dissolves the edge parts of formed pits so as to smooth the edge parts. After that, the aluminum sheet is washed by water spray.

(i) Desmut Treatment

Desmut treatment is carried out by spraying with an aqueous solution of 25% by weight sulfuric acid (containing aluminum ion 0.5% by weight) at 60° C. and then washing the resulting aluminum sheet by water spray.

(j) Anodization Treatment

As an electrolytic solution, sulfuric acid is used. The electrolytic solution contains sulfuric acid 170 g/L (aluminum ion 0.5% by weight) and should be at 43° C. Then the aluminum sheet is washed with a water spray.

The electric current density is about 30 A/dm². Final oxide film thickness is about 2.7 g/m².

The above-mentioned processes (a) to (j) are carried out in succession and the total amount of etching in process (e) is adjusted to be 3.4 g/m² to produce the supporting bodies.

Supporting bodies obtained in the above way are then successively subjected to hydrophilic and undercoating treatments as described below.

(k) Alkali Metal Silicate Treatment

Aluminum supporting bodies obtained by anodization are immersed in a treatment bath of an aqueous solution containing No. 3 sodium silicate 1% by weight for 10 seconds at 30° C. to carry out alkali metal silicate treatment (silicate treatment). After that, the support is washed by water spray. The silicate deposition is about 3.6 mg/m².

(Undercoat Layer Treatment)

Aluminum supporting bodies, after the alkali metal silicate treatment carried out as described above, are coated with an undercoat solution with the following composition and dried at 80° C. for 15 seconds. The coating amount after the drying is 13 mg/m².

Undercoat Solution Composition

| | |
|---|---|
| The following polymer compound | 0.3 g |
| Methanol | 100 g |
| Water | 1.0 g |

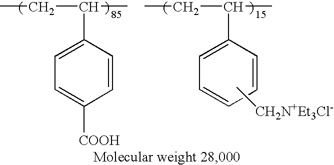

### Examples 1 to 5 and Comparative Example 1

A wire bar having a wet applying amount of 28 mL/m² was used to apply a lower layer coating solution having each composition described below onto supports having an undercoat layer such that the amount of the applied solution would be 0.8 g/m². The resultant materials were dried in a drying oven at a temperature of 150° C. for 60 seconds.

A wire bar having a wet applying amount of 11 mL/m² was used to apply an image recording layer (upper layer) coating solution having a composition described below onto the resultant supports having the lower layer such that the total amount of the applied solution would be 1.0 g/m². After application, the resultant materials were dried in a drying oven at a temperature of 140° C. for 70 seconds so as to form each positive type planographic printing plate precursor.

Lower Layer Coating Solution

Each specific polymer shown in Table 1: each in the amount described in Table 1

| | |
|---|---|
| Copolymer made from | 2.133 g |
| N-(p-aminosulfonylphenyl)methacrylamide, | |
| methyl methacrylate and acrylonitrile | |
| (ratio by mole: 37/30/30, | |
| and weight-average molecular weight: 64000) | |
| Cyanine dye A (having a structure illustrated below): | 0.098 g |
| Cyclohexanedicarboxylic acid anhydride: | 0.100 g |
| Bis(hydroxymethyl)-p-cresol: | 0.090 g |
| p-Toluenesulfonic acid: | 0.05 g |
| Ethyl Violet wherein its counter anion | 0.100 g |
| was changed to 6-hydroxynaphthalenesulfonic acid | |
| 3-Methoxy-4- | 0.03 g |
| diazodiphenylaminehexafluorophosphate | |
| (thermally decomposable compound) | |
| Fluorine-containing surfactant | 0.035 g |
| (trade name: Megafac (transliteration) F-780, | |
| manufactured by Dainippon Ink & Chemicals, Inc.) | 0.035 g |
| Methyl ethyl ketone: | 26.6 g |
| 1-Methoxy-2-propanol: | 13.6 g |
| γ-Butyrolactone: | 13.8 g |

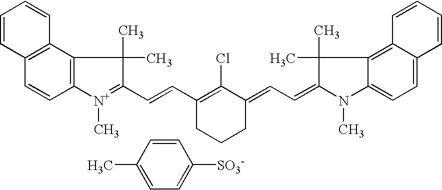

Cyanine dye A

Image Recording Layer (Upper Layer) Coating Solution

| | |
|---|---|
| Copolymer made from | 0.040 g |
| isobutyl methacrylate and methacrylic acid | |
| (ratio by mole: 73/27, and | |
| weight-average molecular weight: 49,000) | |
| Cresol Novolak resin | 0.32 g |
| (trade name: PR-54046, | |
| manufactured by Sumitomo Bakelite Co., Ltd.) | |
| Cyanine dye B (having a structure illustrated below): | 0.008 g |
| Tetrabutylammonium bromide: | 0.030 g |
| Fluorine-containing surfactant | 0.035 g |
| (trade name: Megafac (transliteration) F-780, | |
| manufactured by Dainippon Ink & Chemicals, Inc.) | |
| 1-Methoxy-2-propanol: | 40.2 g |

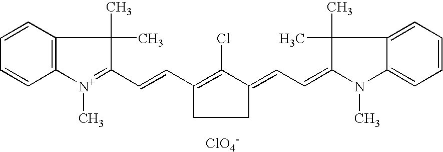

Cyanine dye B

[Evaluation of Development Latitude and Sensitivity]

Each of the resultant planographic printing plate precursors was stored at a temperature of 25° C. and a relative humidity of 50% for 5 days, and then a device, Trendsetter 3244VX manufactured by Creo Co. was used to record a test pattern imagewise thereon at a beam strength of 9.0 W and a drum rotating rate of 150 rpm.

Thereafter, while the temperature of the liquid was kept at 30° C., the planographic printing plate precursor was developed for a developing time of 14 seconds by use of the device PS processor 900H, manufactured by Fuji Photo Film Co., Ltd. charged with developer DT-2, manufactured by Fuji Photo Film Co., Ltd., the electric conductivity of which developer was varied by a change in the diluting rate thereof on the basis of a change in the water amount therein. At this time, the following was defined as the development latitude thereof: the difference between the highest electric conductivity and the lowest electric conductivity of the developers which caused no image portions to be eluted out, gave no stain or color resulting from the remaining recording film due to poorness in the development, and gave images good in contrast. The larger this difference, the better in development latitude and contrast is the image formed. The results are shown in Table 1.

[Evaluation of Sensitivity]

A test pattern was recorded imagewise onto each of the resultant planographic printing plate precursors using the device Trendsetter 3244VX manufactured by Creo Co. to change the exposure energy. Thereafter, the planographic printing plate precursor was developed with the alkaline developer having electric conductivity midway between (the average value of) the highest electric conductivity and the lowest electric conductivity of the developers which caused no image portions to be eluted out, gave no stain or color resulting from the remaining recording film due to poorness in the development and gave images good in contrast in the above-mentioned development latitude evaluation. The exposure value (i.e., the beam strength when the drum rotating speed was 150 rpm) at which the non-image portions were able to be developed with this developer was measured. This was defined as the sensitivity of the planographic printing plate precursor. The smaller this numerical value, the higher the sensitivity.

[Evaluation of Resolution]

In the device Trendsetter 3244VX manufactured by Creo Co., a Staccato 20 screen (manufactured by Creo Co.) was used to expose dots (area ratio: 50%) on each of the planographic printing plate precursors at a power of 8.0 W (150 rpm). The planographic printing plates were developed and then image reproducibility was evaluated by observing the form of the dots with a microscope, and further assessed by measuring image density. The closer the reproducibility is to 50%, which was the area ratio of the outputted image, the reproducibility is better and evaluated as a higher resolution.

TABLE 1

| | Specific polymer/ | Development | | |
|---|---|---|---|---|
| | added amount | latitude | Sensitivity | Resolution |
| | (g) | (mS/cm) | (W) | (%) |
| Example 1 | A/0.210 | 7 | 4.0 | 50 |
| Example 2 | B/0.170 | 6 | 4.5 | 49 |
| Example 3 | C/0.210 | 6 | 4.0 | 48 |
| Example 4 | D/0.170 | 6 | 4.5 | 50 |
| Example 5 | E/0.170 | 8 | 5.0 | 50 |
| Comparative | None | 4 | 5.0 | 46 |
| Example 1 | | | | |

A: Copolymer made from Light Ester (transliteration) HO-HH (manufactured by Kyoeisha Chemical Co., Ltd.) and methyl methacrylate (manufactured by Wako Pure Chemicals, Industries) (copolymerization ratio (ratio by mole): 40/60, and weight-average molecular weight: 75,000).

B: Copolymer made from Light Ester (transliteration) HO-HH (manufactured by Kyoeisha Chemical Co., Ltd.) and ethyl methacrylate (manufactured by Wako Pure Chemicals, Industries) (copolymerization ratio (ratio by mole): 45/55, and weight-average molecular weight: 88,000).

C: Copolymer made from Light Acrylate (transliteration) HOA-HH (manufactured by Kyoeisha Chemical Co., Ltd.) and butyl acrylate (manufactured by Wako Pure Chemicals, Industries) (copolymerization ratio (ratio by mole): 47/53, and weight-average molecular weight: 110,000).

D: Copolymer made from Light Ester (transliteration) HO-HH (manufactured by Kyoeisha Chemical Co., Ltd.), methyl methacrylate (manufactured by Wako Pure Chemicals, Industries) and dodecyl methacrylate (manufactured by Wako Pure Chemicals, Industries) (copolymerization ratio (ratio by mole): 35/60/5, and weight-average molecular weight: 46,000).

E: Copolymer made from Light Ester (transliteration) HO-HH (manufactured by Kyoeisha Chemical Co., Ltd.), ethyl methacrylate (manufactured by Wako Pure Chemicals, Industries) and FA-513M (manufactured by Hitachi Chemical Co., Ltd.) (copolymerization ratio (ratio by mole): 38/40/22, and weight-average molecular weight: 77,000).

* In the synthesis of each of the specific polymers, a polymerization initiator (trade name: V-601, manufactured by Wako Pure Chemicals, Industries) was used.

The weight-average molecular weights represent values, obtained by GPC, relative to standard polystyrene.

As is evident from Table 1, in the planographic printing plate precursors of Examples 1 to 5, which each contained the lower layer containing the specific polymer according to the invention, images were formed which were superior in development latitude, sensitivity and contrast and higher in resolution. In the planographic printing plate precursor of Comparative Example 1, which had the lower layer containing no specific polymer according to the invention, both the development latitude and the sensitivity thereof were poor, and the resolution was also lower than in Examples 1 to 5.

The examples given above demonstrate that the image recording material of the invention is useful as a planographic printing plate precursor.

1. An infrared laser-sensitive positive type image recording material, which comprises:
a support,
an alkali-developer-soluble first layer formed over the support, and
a second layer formed over the first layer, with the solubility in alkali-developer of the second layer being improved by exposure of the second layer to an infrared laser;
wherein the first layer comprises a polymer having a structural unit represented by formula (I): 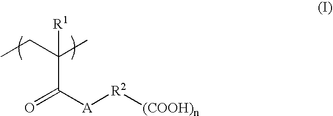
wherein R¹ represents a hydrogen atom or a methyl group; R² represents a hydrocarbon group having (n+1) valences and having an aliphatic ring structure having 3 to 30 carbon atoms; A represents an oxygen atom or —NR³— wherein R³ represents a hydrogen atom or a monovalent hydrocarbon group having 1 to 10 carbon atoms; and n is an integer of from 1 to 5.

2. The infrared laser-sensitive positive type image recording material according to claim 1, wherein the hydrocarbon group having the (n+1) valences and having the aliphatic ring structure is a hydrocarbon group obtained by removing (n+1) hydrogen atoms from the carbon atoms constituting a compound having an aliphatic ring structure, and thereby making the carbon atoms have (n+1) valences.

3. The infrared laser-sensitive positive type image recording material according to claim 1, wherein one or more of the carbon atoms constituting a compound having an aliphatic ring structure are substituted with hetero atoms selected from nitrogen, oxygen and sulfur atoms.

4. The infrared laser-sensitive positive type image recording material according to claim 1, wherein the aliphatic ring structure has two or more aliphatic rings, and may have a substituent.

5. The infrared laser-sensitive positive type image recording material according to claim 4, wherein the aliphatic ring structure has 5 to 30 carbon atoms.

6. The infrared laser-sensitive positive type image recording material according to claim 4, wherein the aliphatic ring structure is selected from a condensed poly-ring aliphatic hydrocarbon, a bridged-ring aliphatic hydrocarbon, a spiro-aliphatic hydrocarbon, and an aliphatic hydrocarbon ring cluster.

7. The infrared laser-sensitive positive type image recording material according to claim 1, wherein n is 1.

8. The infrared laser-sensitive positive type image recording material according to claim 1, wherein the molecular weight of the polymer is in the range of 2,000 to 1,000,000.

9. The infrared laser-sensitive positive type image recording material according to claim 1, wherein the polymer comprises only the structural unit represented by formula (I).

10. The infrared laser-sensitive positive type image recording material according to claim 1, wherein the polymer is a copolymer comprising the structural unit represented by formula (I) and a different structural unit.

11. The infrared laser-sensitive positive type image recording material according to claim 10, wherein the amount of the structural unit represented by formula (I) is 5% or more by mole of the polymer.

12. The infrared laser-sensitive positive type image recording material according to claim 10, wherein the different structural unit is selected from (meth)acrylic acid and derivatives thereof, styrene and derivatives thereof, and acrylonitrile.

13. The infrared laser-sensitive positive type image recording material according to claim 12, wherein the different structural unit is one of the derivatives of (meth)acrylic acid.

14. The infrared laser-sensitive positive type image recording material according to claim 13, wherein the different structural unit is an alkyl (meth)acrylate having an alkyl group having 1 to 4 carbon atoms.

15. An infrared laser-sensitive positive type image recording material, which comprises:
a support, and
a photosensitive/thermosensitive layer formed over the support, the solubility thereof in alkali-developer being improved by exposure of the layer to an infrared laser;
wherein the photosensitive/thermosensitive layer comprises (A) an alkali-soluble resin, (B) a photothermal conversion material, and (C) a polymer having a structural unit represented by formula (I): 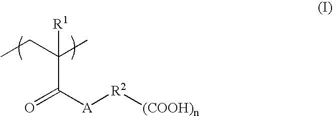
wherein R¹ represents a hydrogen atom or a methyl group; R² represents a hydrocarbon group having (n+1) valences and having an aliphatic ring structure having 3 to 30 carbon atoms; A represents an oxygen atom or —NR³— wherein R³ represents a hydrogen atom or a monovalent hydrocarbon group having 1 to 10 carbon atoms; and n is an integer of from 1 to 5.

16. The infrared laser-sensitive positive type image recording material according to claim 15, wherein the photosensitive/thermosensitive layer comprises:
an alkali-developer-soluble first layer formed over the support, and
a second layer formed over the first layer, the solubility of the second layer in alkali-developer being improved by exposure of the second layer to the infrared laser;
wherein the first layer comprises the polymer having the structural unit represented by formula (I).

17. The infrared laser-sensitive positive type image recording material according to claim 15, wherein the hydrocarbon group having the (n+1) valences and having the aliphatic ring structure is a hydrocarbon group obtained by removing (n+1) hydrogen atoms from the carbon atoms constituting a compound having an aliphatic ring structure, and thereby making the carbon atoms have (n+1) valences.

18. The infrared laser-sensitive positive type image recording material according to claim 15, wherein one or more of the carbon atoms constituting a compound having the aliphatic ring structure are substituted with hetero atoms selected from nitrogen, oxygen and sulfur atoms.

19. The infrared laser-sensitive positive type image recording material according to claim 15, wherein the aliphatic ring structure has two or more aliphatic rings and may have a substituent.

20. The infrared laser-sensitive positive type image recording material according to claim 15, wherein the polymer is a copolymer comprising the structural unit represented by formula (I) and a different structural unit.
